(19) United States
(12) Patent Application Publication
(10) Pub. No.: US 2024/0054273 A1
(43) Pub. Date: Feb. 15, 2024

(54) MEMORY DEVICE WITH BACKSIDE INTERCONNECTION FOR POWER RAIL AND BITLINE AND METHOD OF FORMING THE SAME

(71) Applicant: TAIWAN SEMICONDUCTOR MANUFACTURING COMPANY LTD., HSINCHU (TW)

(72) Inventor: JHON JHY LIAW, HSINCHU COUNTY (TW)

(21) Appl. No.: 17/818,377

(22) Filed: Aug. 9, 2022

(51) Int. Cl. G06F 30/392; H01L 27/11

(52) U.S. Cl. CPC G06F 30/392; H01L 27/1104; G06F 2119/06

(57) ABSTRACT

A method includes receiving design data of a memory device; and generating a design layout including a first cell according to the design data. The first cell includes a first, a second, a third, and a fourth gate structures parallel to each other. The first cell further includes: a data storage element arranged including a first data node and a second data node, wherein the data storage element further comprises four transistors associated with the second and the third gate structures; a first access transistor and a second access transistor coupled to the first data node and the second data node, respectively; a first conductive line coupled to gate structures of the first access transistor and the second access transistor, respectively; and a second conductive line and a third conductive line each coupled to a source/drain region of the respective first and second access transistors.

### BACKGROUND

A basic SRAM memory unit generally includes a pair of cross-coupled inverters serving as a latch to store data bits. In a typical six-transistor (6T) memory unit, the inverters may be accessible through a single-port read/write operation in which one read operation or one write operation is allowed for accessing one memory unit at one time. Moreover, multiple sets of access transistors may be incorporated for implementing multi-port read operations in which multiple data readings are performed on a single or multiple memory units at the same time.

### BRIEF DESCRIPTION OF THE DRAWINGS

Aspects of the embodiments of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 is a circuit diagram of a memory unit, in accordance with some embodiments of the present disclosure.

FIGS. 2A and 2B are a top view and a bottom view, respectively, of a cell of the memory unit shown in FIG. 1, in accordance with some embodiments of the present disclosure.

FIG. 2C shows a cross-sectional view of a layer arrangement of a design layout in a vertical direction, in accordance with some embodiments of the present disclosure.

FIGS. 3A and 3B are a top view and a bottom view, respectively, of a design layout of a pair of memory units, in accordance with some embodiments of the present disclosure.

FIG. 3C is a plan view of different layers of the design layout shown in FIGS. 3A and 3B, in accordance with some embodiments of the present disclosure.

FIGS. 4A and 4B are a top view and a bottom view, respectively, of a cell of a memory unit, in accordance with some embodiments of the present disclosure.

FIG. 5A is a top view of a cell of a memory unit, in accordance with some embodiments of the present disclosure.

FIGS. 5B to 5D are bottom views of a cell of the memory unit shown in FIG. 5A, in accordance with some embodiments of the present disclosure.

FIG. 6A is a top view of a cell of a memory unit, in accordance with some embodiments of the present disclosure.

FIGS. 6B and 6C are bottom views of the cell shown in FIG. 6A, in accordance with some embodiments of the present disclosure.

FIGS. 7A and 7B are a top view and a bottom view, respectively, of a cell of a memory unit, in accordance with some embodiments of the present disclosure.

FIG. 8 is a top view of a design layout of a pair of memory units, in accordance with some embodiments of the present disclosure.

FIG. 9A is a block diagram a memory device, in accordance with some embodiments of the present disclosure.

FIG. 9B is a block diagram a memory device, in accordance with some comparative examples of the present disclosure.

FIG. 10 is a flowchart of a method of manufacturing a semiconductor device, in accordance with some embodiments of the present disclosure.

FIG. 11A is a schematic diagram showing an integrated circuit (IC) manufacturing system, in accordance with some embodiments.

FIG. 11B is a schematic diagram of a system for implementing a design layout, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, although the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the deviation normally found in the respective testing measurements. Also, as used herein, the terms “about,” “substantial” or “substantially” generally mean within 10%, 5%, 1% or 0.5% of a given value or range. Alternatively, the terms “about,” “substantial” or “substantially” mean within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “about,” “substantial” or “substantially.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as being from one endpoint to another endpoint or between two endpoints. All ranges disclosed herein are inclusive of the endpoints, unless specified otherwise.

The term “standard cell” or simply “cell” used throughout the present disclosure refers to a predetermined group of circuit patterns in a design layout to implement specific functionalities of a circuit. A cell is generally comprised of one or more layers, and each layer includes various patterns expressed as polygons of the same or various shapes. A design layout may be generated by placement of one or more cells in allocated locations of a blank layout. In some cases, after the placement step, the placed cells are electrically connected using an interconnect structure. The geometries of the patterns in the cells may be adjusted at different stages of a design flow in order to compensate for design and process effects. The cells may be accessible from cell libraries provided by semiconductor manufacturers or designers. In some cases, the cell library may be stored in a non-transitory computer-readable storage medium and accessed by a processor in various circuit design stages.

Throughout the present disclosure, the standard cells are designed for implementing electronic circuits or memory devices formed by semiconductor devices, e.g., a metal-oxide-semiconductor (MOS) field-effect transistor (FET) device, and can be a planar FET device, a fin-type FET (FinFET) device, a gate-all-around (GAA) device, a nanosheet device, a nanowire device, a fully-depleted silicon-on-isolator (FDSOI) device, or the like.

Some embodiments of the present disclosure provide a new static random-access memory (SRAM) unit structure. Each memory unit of the proposed SRAM is arranged with a cell height and a cell width in a design layout, where the cell height is substantially equal to two times the cell height of the existing SRAM cell, and the cell width is substantially reduced to substantially one half of the existing SRAM cell. Therefore, the new memory array has approximately the same footprint per memory unit, but the interconnection routing efficiency is improved due to the increased spacing of the cell height. In addition, a backside interconnection scheme is incorporated into the new memory unit design, where at least one of bitline pairs, e.g., the bitline (BL) and complementary bitline (BLB), is arranged on the backside of the memory unit. As a result, the routing flexibility of the complementary bitline pairs is increased, and the line width or line spacing of the complementary bit line pairs or other circuit interconnections can be enlarged. The memory speed and power can be therefore enhanced without sacrificing additional memory unit areas.

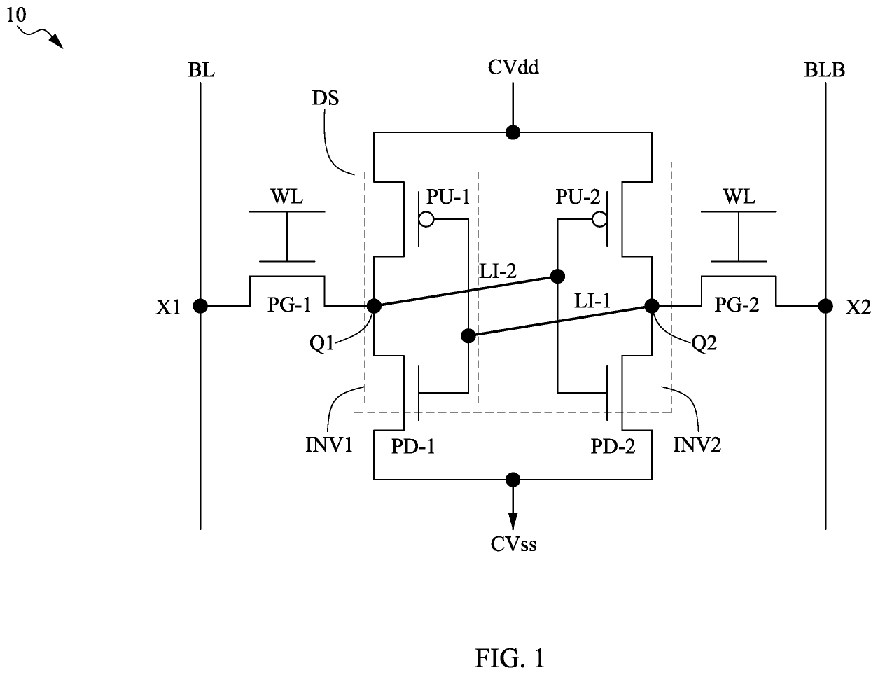

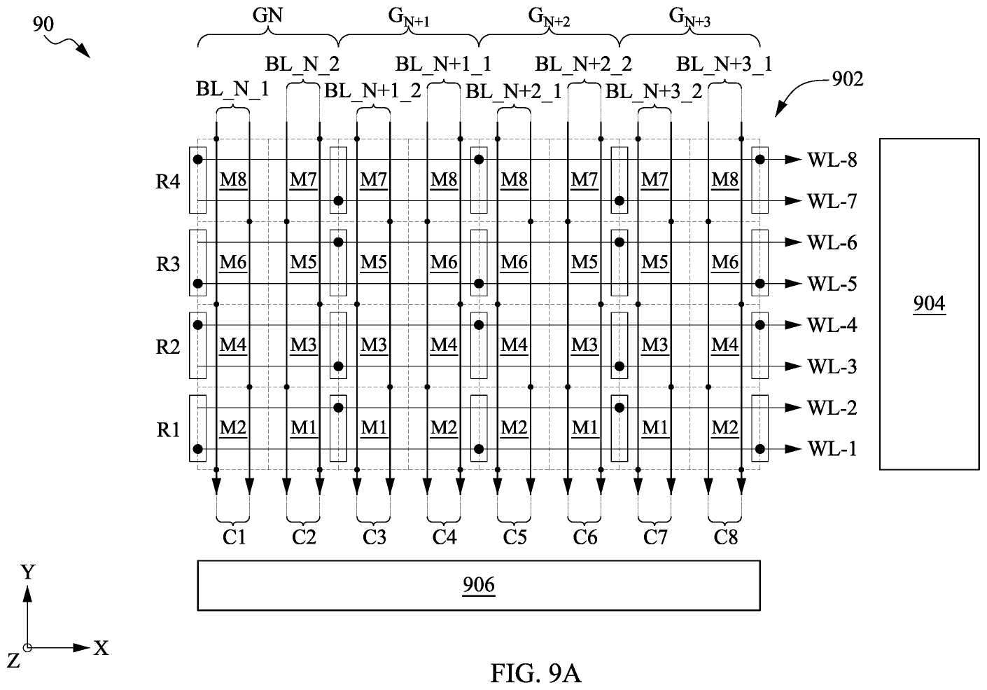

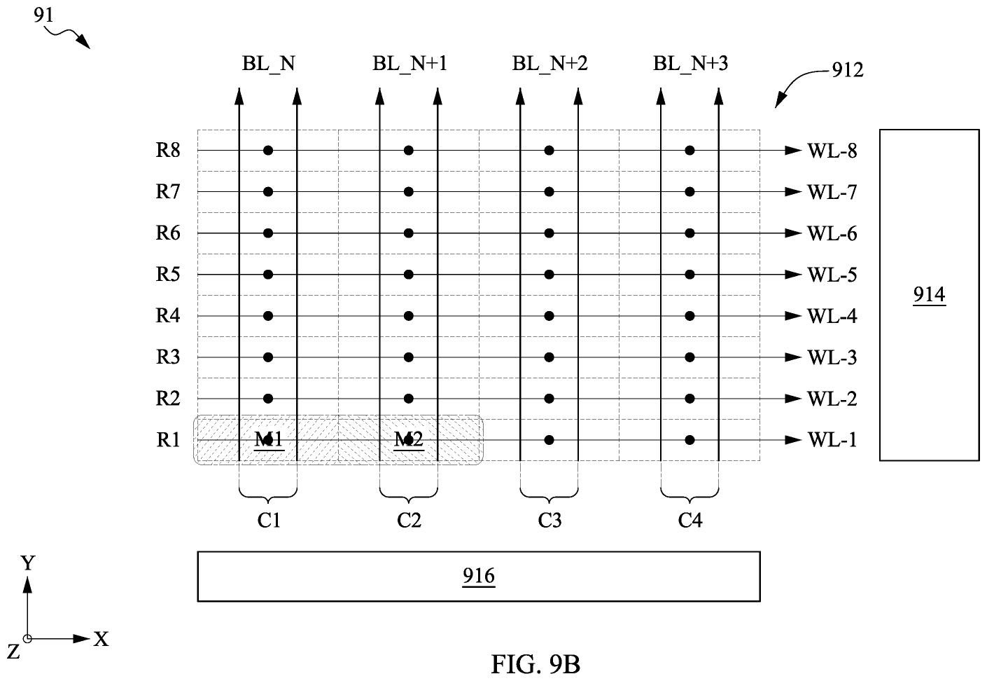

FIG. 1 is a circuit diagram of an exemplary memory unit 10, in accordance with some embodiments of the present disclosure. In some embodiments, the memory unit 10 is an SRAM unit or SRAM cell. Although not shown in FIG. 1, an SRAM memory array can be formed of a plurality of the memory units 10 arranged in columns and rows (FIG. 9A illustrates a memory array 902). In some embodiments, the memory unit 10 is a six-transistor (6T) SRAM comprised of six transistors. In addition, the memory array may include a column decoder, a row decoder, a sense amplifier, a write driver, etc. for accomplishing an access operation of the memory unit 10, e.g., a read operation or a write operation.

The memory unit 10 includes a data storage element DS, a pair of complementary bit lines (referred to as bitline (BL) and bitline_bar (BLB)), a word line WL, and two access transistors PG-1 and PG-2. In an embodiment, the data storage element DS and the access transistors (also referred to as pass gates) PG-1 and PG-2 are constructed by metal-oxide-semiconductor field-effect transistors (MOSFETs). However, other types of transistors, such as bipolar transistors, may also be used. The data storage element DS is formed of two inverters INV1 and INV2 each including a pull-up transistor (e.g., constructed by a P-type transistor) PU-1 or PU-2 and a pulldown transistor (e.g., constructed by an N-type transistor) PD-1 or PD-2. The sources of the pull-up transistor PU-1 or PU-2 are coupled to a first supply voltage, such as a common positive-voltage power source (labelled as CVdd), and the sources of the pull-down transistor PD-1 or PD-2 are coupled to a second supply voltage, such as common ground or common negative-voltage power source (labelled as CVss). The gate terminals of the pull-up transistor PU-1 and the pulldown transistor PD-1 are connected, and the gate terminals of the pull-up transistor PU-2 and the pulldown transistor PD-2 are connected. The two inverters INV1 and INV2 are cross-coupled to each other, e.g., the gate terminal of the pull-up transistor PU-1 is electrically connected to the common source/drain terminal of the inverter INV2, while the gate terminal of the pull-up transistor PU-2 is electrically connected to the common source/drain terminal of the first inverter INV1, so that a latch or two flip-flops are formed to keep one bit of data stored at a data node (or data terminal) Q1 and another data node (or data terminal) Q2 with a pair of complementary logic values (i.e., a pair of ‘ l’ and ‘0’, or a pair of ‘0’ and ‘1’). The data nodes Q1 and Q2 thus are kept at a bi-stable state.

The first source/drain terminal of the access transistor PG-1 is connected to the bit line BL at a node X1 and the second source/drain terminal of the access transistor PG-1 is connected to the data storage element DS at the node Q1. Similarly, the first source/drain terminal of the access transistor PG-2 is connected to the complementary bit line BLB at a node X2 and the second source/drain terminal of the access transistor PG-2 is connected to the data storage element DS at the node Q2. The access transistor PG-1 or PG-2 can be a P-type transistor or an N-type transistor. In an embodiment, the access transistors PG-1 and PG-2 are of the same transistor type, i.e., either P-type or N-type. During an access (read or write) operation, the access transistors PG-1, PG-2 are activated to enable data transfer between the data nodes Q1, Q2 and the node X1, X2 on the bit lines BL and BLB. In the depicted embodiment, the access transistor PG-1 and PG-2 are N-type transistors.

The access transistors PG-1 and PG-2 are controlled through a biasing voltage provided by a common word line select signal WL through the gate terminals of the access transistors PG-1 and PG-2. The biasing voltage of the word line select signal WL may be the first supply voltage CVdd. Alternatively, a ground or negative voltage (e.g., the second supply voltage CVss) may be used to activate the P-type access transistor PG-1 or PG-2.

The memory unit 10 may further include pre-charge transistors (not separately shown) coupled to the bit lines BL and BLB. Also, the bitlines BL and BLB are electrically connected to the sensing amplifier or the write driver. In some embodiments, the pre-charge transistor has a conductivity type different from that of the access transistor PG-1 or PG-2.

In an embodiment, before a read operation is performed, the pre-charge transistors are activated so that the bit lines BL and BLB are pulled up or down from an initial voltage to a first voltage. In an embodiment, the first voltage is set as an intermediate value between the ground and the first supply voltage CVdd, such as CVdd/2 or other suitable voltages. When a read operation is performed, the access transistors PG-1 and PG-2 are selected and turned on, the data values stores at the data nodes Q1 and Q2 will drive the bit lines BL and BLB toward opposite directions with a voltage difference, and the voltage difference is sent to the sensing amplifier to be amplified during data sensing. The bit stored in the memory unit 10 can therefore be detected through the sensing amplifier.

In some embodiments, during a write operation, the bit lines BL and BLB are precharged with complementary data logic levels representing the data bit. When the access transistors PG-1, PG-2 are selected and turned on, the voltages on the data nodes Q1 and Q2 are driven by the voltages on the bit lines BL and BLB so that the data bit is written into the memory unit 10, and thus the cross-coupled inverters INV1 and INV2 are kept at the original state or the inverse state to complete the write operation.

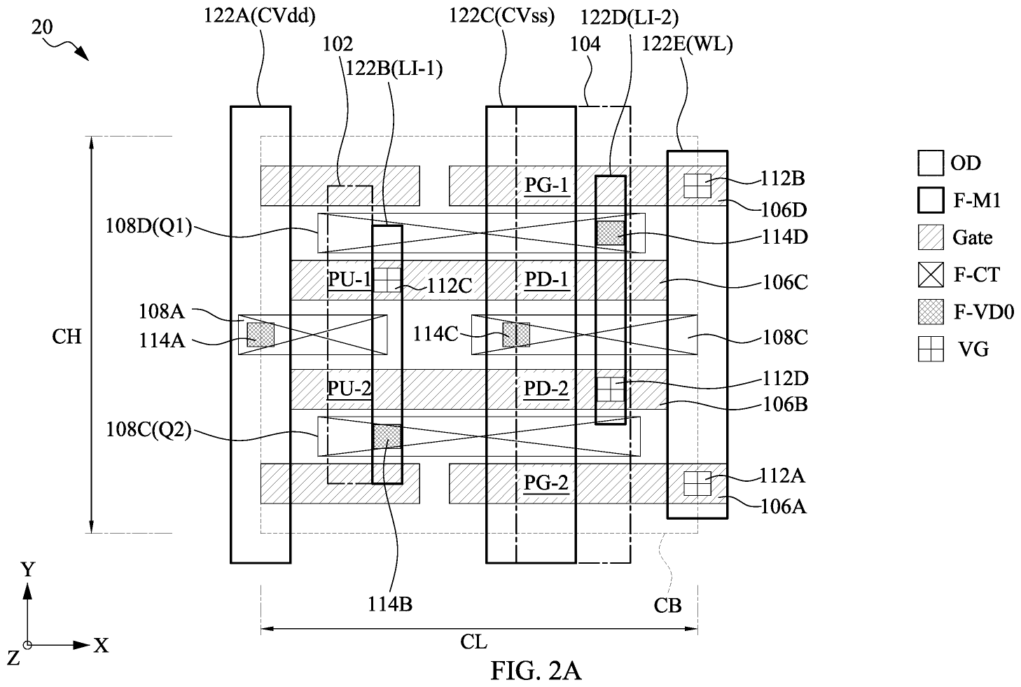

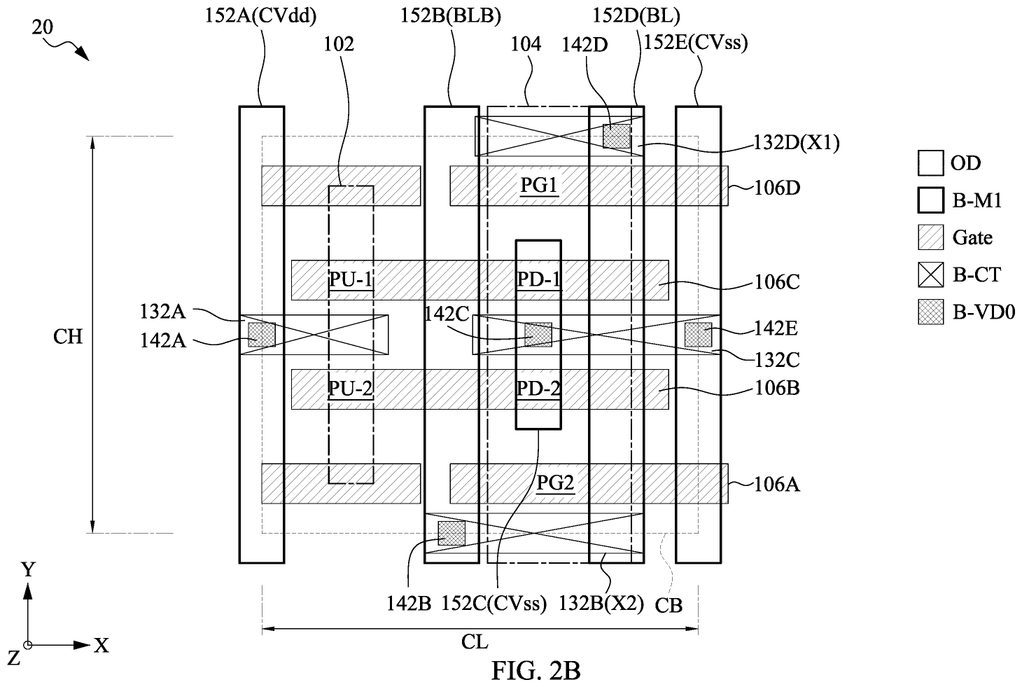

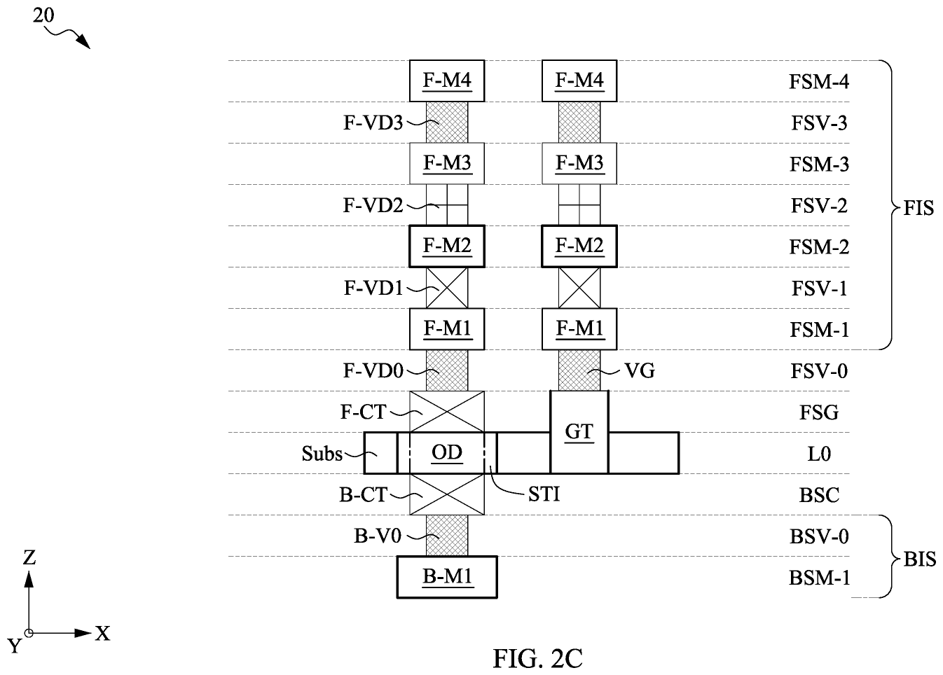

FIGS. 2A and 2B are a top view and a bottom view, respectively, of a cell 20 associated with the memory unit 10 shown in FIG. 1, in accordance with some embodiments of the present disclosure. FIG. 2C shows a cross-sectional view of a layer arrangement of the cell 20 in a vertical direction, in accordance with some embodiments of the present disclosure.

Referring to FIG. 2C, a device layer, labeled by “LO,” is formed or provided, in which a substrate, labeled by “Subs,” is formed. The substrate may include silicon, germanium, or other suitable elementary semiconductor materials. Alternatively, the substrate may include a compound semiconductor, such as silicon carbide, gallium arsenide, indium arsenide, or indium phosphide. The substrate may include different dopant types, such as P-type substrate or an N-type substrate, and may include various doping configurations depending on design requirements. Further, the substrate may include an epitaxial layer (epi layer) or may include a silicon-on-insulator (SOI) structure. In some embodiments, the substrate is a metallization layer and formed of a semiconductor material or a dielectric material.

An active region, denoted by “OD” in FIG. 2C, is arranged in the device layer LO and exposed through an upper surface of the substrate. Although not separately shown, the active region OD may include a first source/drain region, a second source/drain region and a channel of a FET interposed between the two source/drain regions. The source/drain regions in the active region may be an N-type active region doped with N-type impurities such as arsenic, phosphorus, or the like, or a P-type active region doped with P-type impurities such as boron or the like. The channel in the active region OD may be undoped or lightly doped. Throughout the present disclosure, the source/drain region(s) may refer to a source or a drain, individually or collectively, dependent upon the context. In embodiments where a raised active region or a FinFFT is involved, the active region OD may protrude from the upper surface of the substrate. In some embodiments, the device layer LO further includes isolation structures STI defining and laterally surrounding the active region OD. In some embodiments, the isolation structures STI are formed of dielectric materials, such as oxide, nitride, carbide, oxynitride, a combination thereof, or the like, and may be referred to as shallow trench isolation (STI).

A gate structure, denoted by “GT” in FIG. 2C, is formed in a front-side gate layer FSG over the device layer LO. The gate structure GT may extend in the horizontal direction (e.g., X-axis) and include a gate dielectric layer and a gate electrode (not separately shown). The gate dielectric layer may be formed of dielectric materials, such as oxide, nitride, or high-k dielectric material, and arranged between the channel and the gate electrode. The gate electrode may include a conductive material, such as doped polysilicon or a metal gate comprising metallic materials such as tungsten, and cobalt, and other work function adjusting metals, such as Ti, Al, TiAl, TiN, TaC, and the like. In embodiments where a FinFFT or a GAA FET is adopted, the gate structure GT may overlap the active region OD in the vertical direction (Z-axis). For example, in a GAA FET, the active region OD is formed of multiple nanosheets or nanowires, and each of the nanosheets or nanowires is wrapped around by the gate structure GT. The two sides of the nanosheets or nanowires are covered by the source/drain regions of the active region OD.

In some embodiments, the gate structure GT is classified into a functional gate structure and a non-functional gate structure. The functional gate structure serves as the gate terminal of a FET and configured to receive a gate control biasing voltage. The non-functional gate structure is not part of any FET, but serves as an isolation structure between neighboring FETs. The gate electrode of the non-functional gate structure may be replaced by a dielectric material, or its conductive gate electrode is a tie-off gate electrode such that the function of the gate electrode is disabled.

A front-side gate-layer conductive line, denoted by “F-CT” in FIG. 2C, is also arranged in the front-side gate layer FSG over the active region OD adjacent to the gate structure GT. The front-side gate-layer conductive line F-CT is configured as a front-side contact of the source/drain region. In some embodiments, the front-side gate-layer conductive line F-CT extends in the direction of the X-axis (e.g., the row direction) and is parallel to the direction where the gate structure GT extends. Likewise, a backside conductive line, denoted by “B-CT” in FIG. 2C, is also arranged in a backside contact layer BSC below the device layer LO. The backside conductive line B-CT is configured as a backside contact of the source/drain regions below the active region OD. In some embodiments, the backside conductive line B-CT extends in the direction of the X-axis and is parallel to the direction where the gate structure GT extends.

The cell 20 includes a front-side interconnect structure FIS and a backside interconnect structure BIS on two sides of the device layer LO. In some embodiments, the front-side interconnect structure FIS is arranged over the front-side gate layer FSG and configured to electrically interconnect the terminals of the FETs in the device layer LO and the front-side gate layer FSG, or electrically connect the front-side gate-layer conductive lines F-CT of the front-side gate layer FSG to the conductive members in the layers above the front-side interconnect structure FIS. Likewise, the cell 20 further includes a backside interconnect structure BIS below the backside contact layer BSC, and configured to electrically interconnect the terminals of the FETs in the device layer LO and the front-side gate layer FSG, or electrically connect the backside conductive lines B-CT in the backside contact layer BSC to the conductive elements in the underlying layers below the backside interconnect structure BIS. In some embodiments, one of the front-side interconnect structure FIS and the backside interconnect structure BIS, or both, includes a power mesh formed of power rails and configured to provide power and ground to the terminals of the FETs in the device layer LO and the front-side gate layer FSG.

The abovementioned front-side gate-layer conductive lines F-CT and the backside conductive lines B-CT may be formed of conductive materials, e.g., doped silicon or metallic materials, such as copper, tungsten, titanium, aluminum, tantalum, alloys thereof, or the like. In some embodiments, the isolation structures STI are arranged in the device layer LO for electrically insulating the abovementioned conductive members. In some embodiments, although not shown in FIG. 2C, the memory unit 10 includes interlayer dielectric (ILD) layer in the front-side gate layer FSG or the backside contact layer BSC to electrically insulating the gate structure GT, the front-side gate-layer conductive lines F-CT or the backside conductive lines B-CT. The ILD layer may be formed of oxide, nitride, oxynitride, carbide, a combination thereof, or the like.

The front-side interconnect structure FIS includes a plurality of front-side conductive line layers FSM and a plurality of front-side conductive via layers FSV over the front-side gate layer FSG. The labels of the individual front-side conductive line layers FSM are appended with layer indices x, where x is a natural number, e.g., FSM-1, FSM-2, and FSM-3. Similarly, the labels of individual front-side conductive via layers FSV are appended with layer indices x′ (the index x′ of the front-side conductive via layer FSV starts from zero), e.g., FSV-0, FSV-1 and FSV-2. The front-side conductive line layers FSM-x are arranged alternatively with the front-side conductive via layers FSV-x′.

Each of the front-side conductive line layers FSM-x includes a plurality of parallel conductive lines F-Mx, and each of the front-side conductive via layers FSV-x includes conductive vias, e.g., a front-side gate via “VG” or a front-side drain via “F-VDx.” In some embodiments, the front-side gate via VG electrically connects the front-side conductive line F-M1 to the gate structure GT. Furthermore, the bottommost front-side conductive via F-VDO electrically connects the front-side conductive line F-M1 to the front-side gate-layer conductive line F-CT.

In some embodiments, the odd-numbered front-side conductive lines F-Mx, e.g., F-M1 and F-M3, extend along the Y-axis (e.g., the column direction), while the even-numbered front-side conductive lines F-Mx, e.g., F-M2, extend along the X-axis, or vice versa. The adjacent front-side conductive lines F-Mx and F-M(x-1) are electrically interconnected through the intervening front-side conductive via F-VD(x-1). For example, the front-side conductive line layer FSM-2 is electrically connected to front-side conductive line layer FSM-3 through the front-side conductive via layer FSV-2.

The front-side conductive lines F-Mx and the front-side conductive vias F-VG and F-VDx may be formed of conductive materials, such as copper, tungsten, aluminum, titanium, tantalum, alloys thereof, or the like, and may be electrically insulated by an inter-metal dielectric (IMD) layer (not shown). The IMD layer may be formed of a dielectric material, such as silicon oxide, silicon nitride, silicon oxynitride, silicon carbide, combinations thereof, or the like.

The backside interconnect structure BIS includes a plurality of backside conductive line layers BSM and a plurality of backside conductive via layers BSV below the backside contact layer BSC. The labels of the individual backside conductive line layers BSM are appended with layer indices y, where y is a natural number. Similarly, the labels of individual backside conductive via layers BSV are appended with layer indices y′, where y′ is zero or a natural number, e.g., BSV-0. The backside conductive line layers BSM-y are arranged alternatively with the backside conductive via layers BSV-y′.

Each of the backside conductive line layers BSM-y includes a plurality of parallel conductive lines B-My, and each of the backside conductive via layers BSV-y includes conductive vias B-VDy. The backside conductive line layers BSM-y are electrically interconnected through the intervening conductive via layers BSV-y in a manner similar to that of the front-side conductive lines layers FSM-x and front-side conductive via layers FSV-x. The backside conductive lines B-My and the backside conductive vias B-VDy may be formed of conductive materials, such as copper, tungsten, aluminum, titanium, tantalum, alloys thereof, or the like, and may be electrically insulated by an inter-metal dielectric (IMD) layer (not shown). The IMD layer may be formed of a dielectric material, such as silicon oxide, silicon nitride, silicon oxynitride, silicon carbide, combinations thereof, or the like.

In some embodiments, the term “front side” refers to the side of the device layer LO in which the gate structure GT or the front-side gate via VG resides. In some embodiments, the term “front side” refers to the side of the device layer LO in which the gate structure GT or the front-side gate via VG extends outwardly from the device layer LO. In some embodiments, the term “backside” refers to the side of the device layer LO opposite to the front side of the device layer LO.

The number of layers, configurations and materials of the front-side interconnect structure FIS and the backside interconnect structure BIS shown in FIG. 2C are for illustrative purposes only. Other numbers of conductive line layers or conductive via layers, materials, and configurations of the front-side interconnect structure FIS or the backside interconnect structure BIS are also within the contemplated scope of the present disclosure.

Referring to FIGS. 2A and 2B, the features of the device layer LO and the front-side gate layer FSG of the cell 20 are shown. In addition, for clarity of illustration, only the front-side layers of the cell 20 are shown in FIG. 2A while only the backside layers of the cell 20 are shown in FIG. 2B. As shown in FIGS. 2A and 2B, the cell 20 is defined by a cell boundary CB, as illustrated by a dashed box in FIGS. 2A and 2B. The cell boundary CB is formed of an upper cell side, a lower cell side, a right cell side and a left cell side.

In some embodiments, the cell 20 includes a first active region 102 and a second active region 104 arranged in the device layer LO. The first active region 102 and the second active region 104 may extend along the Y-axis. In some embodiments, the first active region 102 is a P-type doped region doped with P-type dopants, e.g., born, indium, or the like, and the second active region 104 is an N-type doped region doped with N-type doped regions, e.g., phosphor, arsenic, or the like. In some embodiments, although not separately shown, the cell 20 includes a first (N-type) well region in the device layer LO below or laterally surrounding the first active region 102, and a second (P-type) well region in the device layer LO below or laterally surrounding the second active region 104. In some embodiments, the first active region 102 is shared by the P-type pull-up transistors PU-1, PU-2, of the memory unit 10, while the second active region 104 is shared by the N-type pulldown transistors PD-1, PD-2, and the access transistors PG-1, PG-2 of the memory unit 10. Therefore, the second active region 104 may have an area greater than the area of the first active region 104. In some embodiments, the cell 20 has a span along the X-axis of three times the width La of an active region, where the width La is predetermined. In some embodiments, the active region 102 has a width La measured in the direction of X-axis, while the active region 104 has a width 2×La measured in the direction of X-axis.

In some embodiments, The cell 20 further includes four gate structures 106A, 106B, 106C, 106D, referred to collectively as gate structures 106, extending along the X-axis. Among the four gate structures 106, the gate structure 106A serves as the gate structure of the access transistor PG-2, the gate structure 106B serves as the gate structures of the pull-up transistor PU-2 and the pulldown transistor PD-2, the gate structure 106C serves as the gate structures of the pull-up transistor PU-1 and the pulldown transistor PD-1, and the gate structure 106D serves as the gate structure of the access transistor PG-1 In some embodiments, the access transistors PG-1, PG-2 are arranged on two sides of the pull-up transistors PU-1, PU-2 and the pull-down transistors PD-1, PD-2. In some embodiments, the active region 102 crosses the gate structures 106B, 106C from a top-view perspective, and the active region 104 crosses the four gate structures 106A through 106D from a top-view perspective.

In some embodiments, the cell 20 includes front-side gate-layer conductive lines 108 extending along the X-axis. The front-side gate-layer conductive lines 108 may be parallel to the gate structures 106 and between adjacent gate structures 106. Further, in some embodiments, the cell 20 includes front-side conductive lines 122 extending along the Y-axis over the front-side gate-layer conductive lines 108.

Referring to FIG. 2A, a front-side conductive line 122A, configured as a front-side power rail of the cell 20 to receive the first supply voltage CVdd, is electrically connected to a common source/drain region of the pull-up transistors PU-1, PU-2 through a front-side gate-layer conductive line 108A and a front-side conductive via 114A over the front-side gate-layer conductive line 108A. In addition, a front-side conductive line 122C, configured a front-side power rail of the cell 20 to receive the second supply voltage CVss, is electrically connected to a common source/drain region of the pull-down transistors PD-1, PD-2 through a front-side gate-layer conductive line 108C and a front-side conductive via 114C over the front-side gate-layer conductive line 108C. In some embodiments, a word line select signal WL is received on the front-side gate-layer conductive line 122E and electrically connected to the gate structures 106A and 106D through front-side gate vias 112A and 112B, respectively.

In some embodiments, the front-side conductive lines 122A and 122E are arranged on the cell boundary CB of the cell 20. In some embodiments, the front-side conductive lines 122A and 122E are aligned with the left cell side and the right cell side, respectively, of the cell 20.

In some embodiments, referring to FIGS. 1 and 2A, the local interconnection LI-1 between the gate structure 106C of the pull-up transistor PU-1 and the pulldown transistor PD-1 and the common source/drain region at the data node Q2 is implemented by a front-side gate-layer conductive line 122B, a front-side gate via 112C electrically connected to the gate structure 106C, and a front-side conductive drain via 114B. Similarly, the local interconnection LI-2 between the gate structure 106B of the pull-up transistor PU-2 and the pulldown transistor PD-2 and the common source/drain region at the data node Q1 is implemented by a front-side conductive line 122D, a front-side gate via 112D electrically connected to the gate structure 106C, and a front-side conductive drain via 114B. In some embodiments, the common source/drain regions representing the data nodes Q1 and Q2 are the outer source/drain regions of the gate structures 106B and 106C; in other words, the common source/drain regions representing the data nodes Q1 and Q2 are on two sides of the space defined by the gate structures 106B, 106C.

Referring to FIG. 2B, a backside conductive line 152A, configured as a backside power rail to receive the first supply voltage CVdd, is electrically connected to the common source/drain region of the pull-up transistors PU-1, PU-2 through a backside conductive line 132A and a backside conductive via 142A below the backside conductive line 132A. In addition, backside conductive lines 152C and 152E, configured as power rails of the cell 20 to receive the second supply voltage CVss, are electrically connected to the common source/drain region of the pull-down transistors PD-1, PD-2 through a backside conductive line 132C and backside conductive vias 142C, 142E below the backside conductive line 132C.

In some embodiments, the backside conductive lines 152A and 152E are arranged on the cell boundary CB of the cell 20. In some embodiments, the backside conductive lines 152A and 152E are aligned with the left cell side and the right cell side, respectively, of the cell 20.

Referring to FIGS. 1 and 2B, in some embodiments, a bitline select signal (BL) is received on a backside conductive line 152D and electrically connected to the data node X1 through a backside conductive line 132D and a backside conductive via 142D below the backside conductive line 132D. In some embodiments, a complementary bitline select signal (BLB) is received on a backside conductive line 152B and electrically connected to the data node X2 through a backside conductive line 132B and a backside conductive via 142B below the backside conductive line 132B. In some embodiments, the backside conductive line 152C arranged between the backside conductive lines 152B and 152D can also serve the function of electric shielding to eliminate cross coupling of signals with different polarities (e.g., signals representing the complementary logic states in the complementary bitlines BL and BLB) transmitted in the backside conductive lines 152B and 152D. In some embodiments, the backside conductive line 152C has a length measured along the Y-axis different from (e.g., less than) the length of the backside conductive line 152E, 152B or 152D.

Based on the above, the cell 20 for the proposed 6T-SRAM includes bit lines BL and BLB on the backside of the cell 20. As a result, the routing area for the bitlines BL/BLB is increased as compared to existing SRAM cells. The line width and line spacing of the backside conductive lines 152B, 152D for the bit lines BL/BLB can be enlarged accordingly. The resistance or capacitance of the bit lines BL/BLB can be decreased. Further, since the bitlines BL/BLB are moved from the front side to the back side of the cell 20, the mutual capacitance between the gate structures 106 and the bitlines BL/BLB is eliminated, which would further lower the total bitline capacitance of the memory unit 10. As a result, the device speed and power of the memory unit 10 can be effectively enhanced.

In some embodiments, the cell 20 has a cell height CH measured along the Y-axis and a cell length CL measured along the X-axis. The cell height CH may be substantially equal to four times a gate pitch, where the gate pitch is defined as a pitch of the parallel gate structures 106. The increased cell height CH and the backside bitline routing scheme would greatly simplify the routing complexity, and therefore the cell length CL can be effectively decreased. In some embodiments, the cell length CL is substantially equal to three times the OD pitch of basic active regions, where the basic active region refers to a predetermined single active region component in a design layout without any merging of active regions. By comparison to a typical existing 6T-SRAM unit, the cell height CH is substantially two times the cell height of the existing 6T-SRAM unit, and the cell length CL is substantially one half of the cell length of the existing 6T-SRAM unit. As a result, the overall cell area of the cell 20 of an exemplary memory unit 10 is substantially equal to the cell area of the existing 6T-SRAM unit. Therefore, the bitline speed and power of the proposed SRAM cell can be enhanced without sacrifice in the cell area. In some embodiments, an aspect ratio CL/CH of the cell 20 is between about 0.5 and about 1.5, or between about 0.6 and about 1.2.

The arrangement of the conductive lines, e.g., power rails for receiving the first supply voltage CVdd and the second supply voltage CVss and the backside conductive lines for implementing the complementary bitlines BL, BLB as shown in FIGS. 2A and 2B are one of the embodiments of the present disclosure. Other arrangements are also within the contemplated scope of the present disclosure. For example, at least one of the conductive lines, including the power rails configured to receive the first supply voltage CVdd and the second supply voltage CVss and the conductive lines for implementing the complementary bitlines BL, BLB, is arranged on the backside of the cell 20.

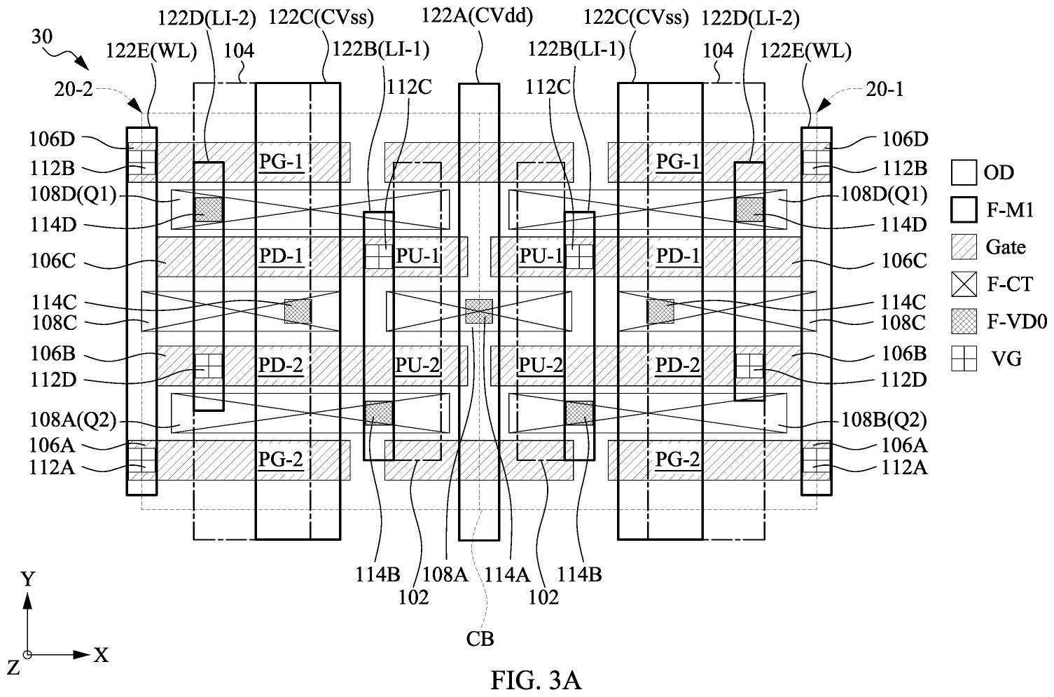

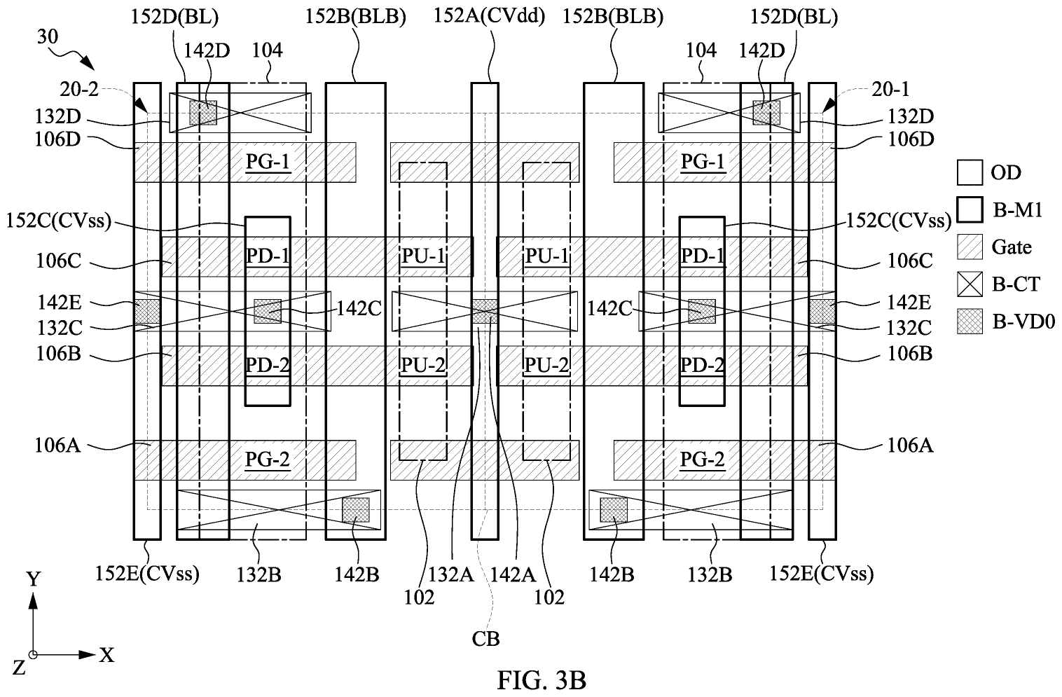

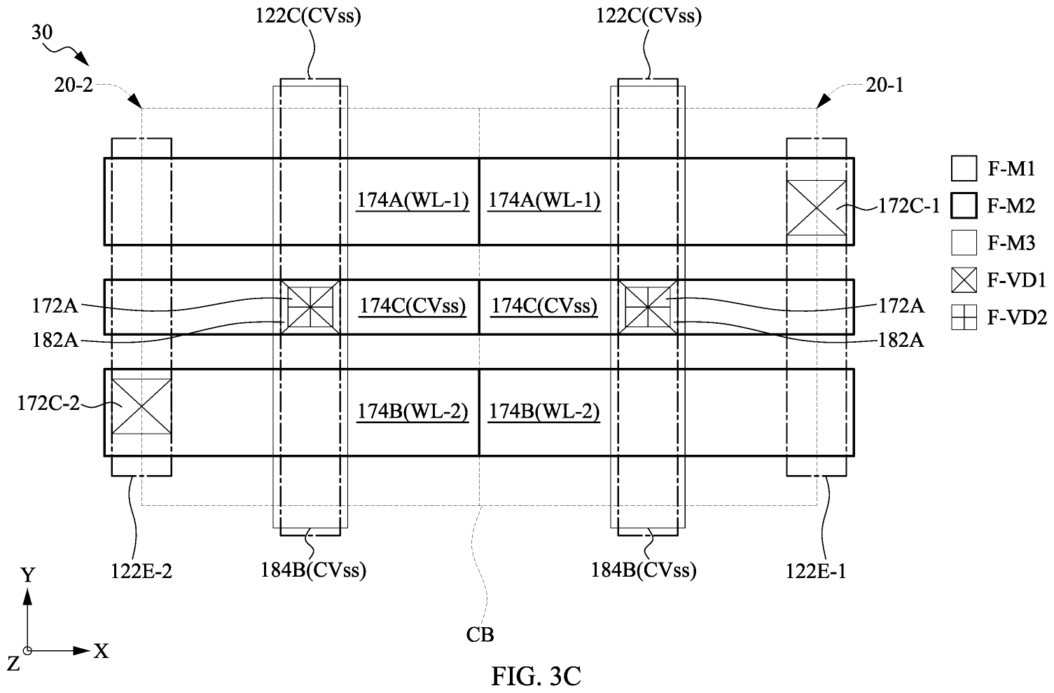

FIGS. 3A and 3B are a top view and a bottom view, respectively, of a design layout 30 of a pair of cells 20, in accordance with some embodiments of the present disclosure. In some embodiments, the design layout 30 includes two instances of the cell 20 shown in FIGS. 2A and 2B, i.e., cells 20-1, 20-2, where the cell 20-2 is a flipped or mirrored version of the cell 20-1 in the horizontal direction and abutted to the cell 20-1. As a result, the front-side conductive line 122A is shared by the two adjoining cells 20-1, 20-2. Similarly, the backside conductive lines 152A is shared by the two adjoining cells 20-1, 20-2. In some embodiments, the cell 20-1 and 20-2 are mirror images to each other, or are symmetrical about the boundary line between the cells 20-1, 20-2. In some embodiments, the backside conductive lines 152E is also shared by the adjoining cells 20. Therefore, by cascading the original cell 20-1 or the mirrored cell 20-2 where appropriate along the X-axis to form a row of the cells 20, and duplicating the row of the cells 20 along the Y-axis, a memory array can be formed.

FIG. 3C is a plan view of different layers of the design layout 30 shown in FIGS. 3A and 3B, in accordance with some embodiments of the present disclosure. Referring to FIG. 3C, the layers on the front side starting from the front-side conductive line 122C (F-M1) are illustrated, and the features of other layers are omitted from FIG. 3C for the sake of clarity. In some embodiments, the front-side conductive line 122C on both cells 20-1 and 20-2 are electrically connected to the front-side conductive lines 184B in the front-side conductive line layer FSM-3, and configured to receive the second supply voltage CVss through the front-side conductive vias 172A in the front-side conductive via layer FSV-1, the front-side conductive line 174C in the front-side conductive line layer FSM-2, and the front-side conductive vias 182A in the front-side conductive via layer FSV-2.

Further, the pair of cells 20-1, 20-2 each receive the word line select signals WL-1 and WL-2 on the front-side conductive lines 174A, 174B in the front-side conductive line layer FSM-2 and electrically connected to the underlying access transistors PG-1, PG-2, through the front-side conductive vias 172C-1, 172C-2 in the front-side conductive via layer FSV-1 and the front-side conductive lines 122E-1, 122E-2 in the conductive line layer FSM-1. As a result, while the front-side conductive lines 174A, 174B extend over both of the cells 20-1, 20-2, only one of the front-side conductive lines 174A, 174B correspond to the word line select signal of one of the cells 20-1, 20-2. In some embodiments, the front-side conductive vias 174C-1, 174C-2 for receiving the word line select signals WL-1, WL-2 of the respective cells 20-1, 20-2 are arranged adjacent to diagonal corners of the design layout 30 with a symmetric manner about the center of the design layout 30. As a result, although the front-side conductive line 122E for receiving the word line select signal is arranged on the cell boundary between the adjacent cells 20-1, 20-2, the arrangement of the pair of the front-side conductive lines 174A, 174B and the pair of the diagonally arranged fronts-side conductive vias 172C-1, 172C-2 can achieve the addressing of the individual cells 20-1, 20-2 without increasing additional routing areas.

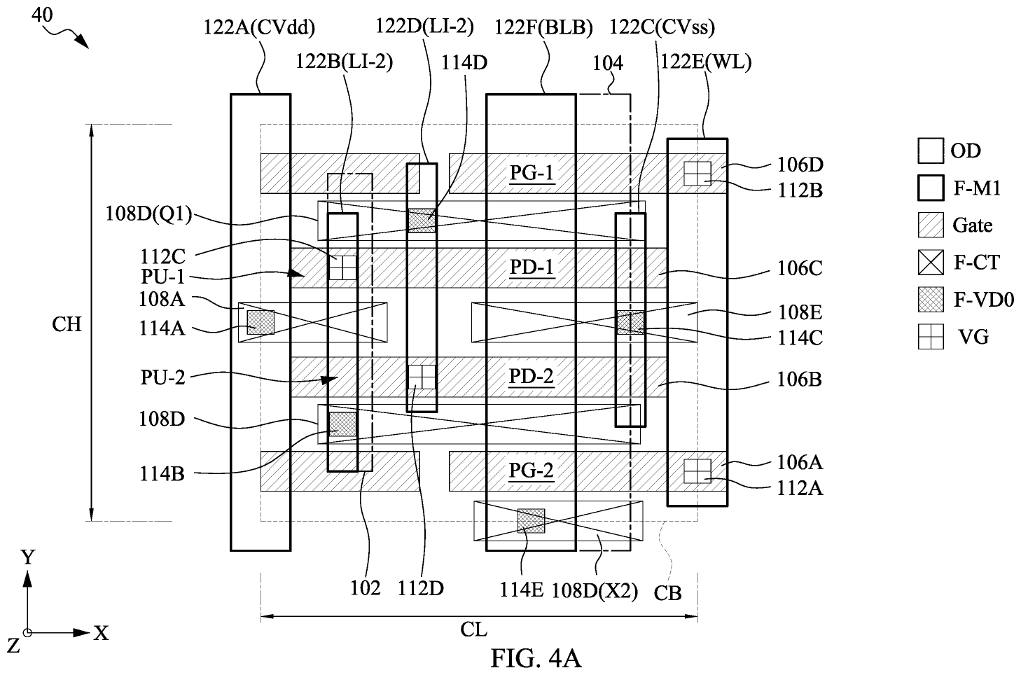

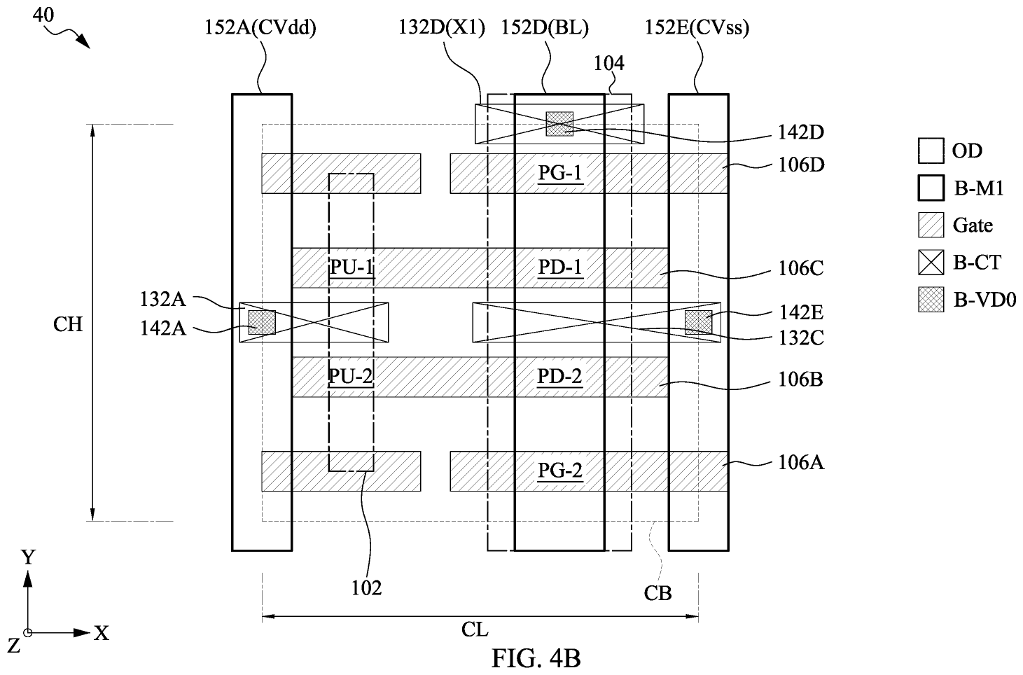

FIGS. 4A and 4B are a top view and a bottom view, respectively, of a design layout of a cell 40 of a memory unit, in accordance with some embodiments of the present disclosure. The cell 40 is similar to the cell 20 in many aspects, and the similar aspects will not be repeated for brevity. The cell 40 is different from the cell 20 in that the complementary bitline (BLB) implemented by the backside conductive lines 152B is replaced by a front-side conductive line 122F formed in the front-side conductive line layer FSM-1 and arranged between the front-side conductive lines 122C and 122D. The front-side conductive line 122F is electrically connected to the front-side gate-layer conductive line 108D (the data node X1) through a front-side conductive via 114E arranged in the front-side conductive via layer FSV-0. In addition, the locations of the front-side conductive lines 122C and 122D are interchanged for adaptation to the movement of the front-side conductive line 122F.

Referring to FIGS. 2B and 4B, the backside conductive line 152C and the backside conductive via 142C are removed from the cell 40. As such, the cell 40 exemplifies the desired layout flexibility for addressing different design requirements. The speed and power of the memory unit 10 implemented by the cell 40 can be enhanced accordingly.

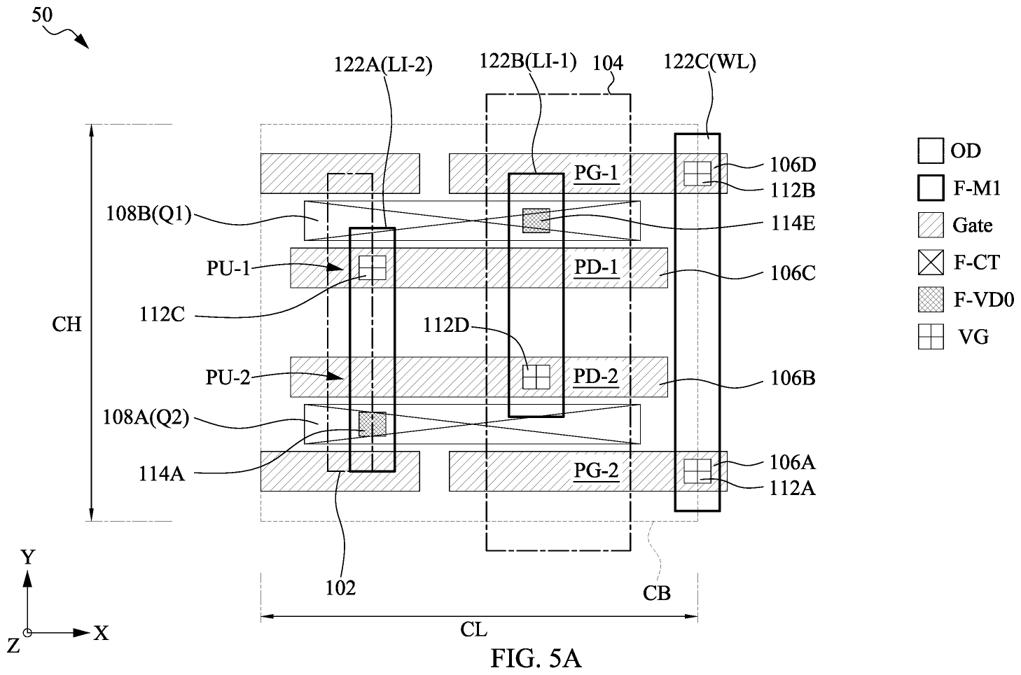

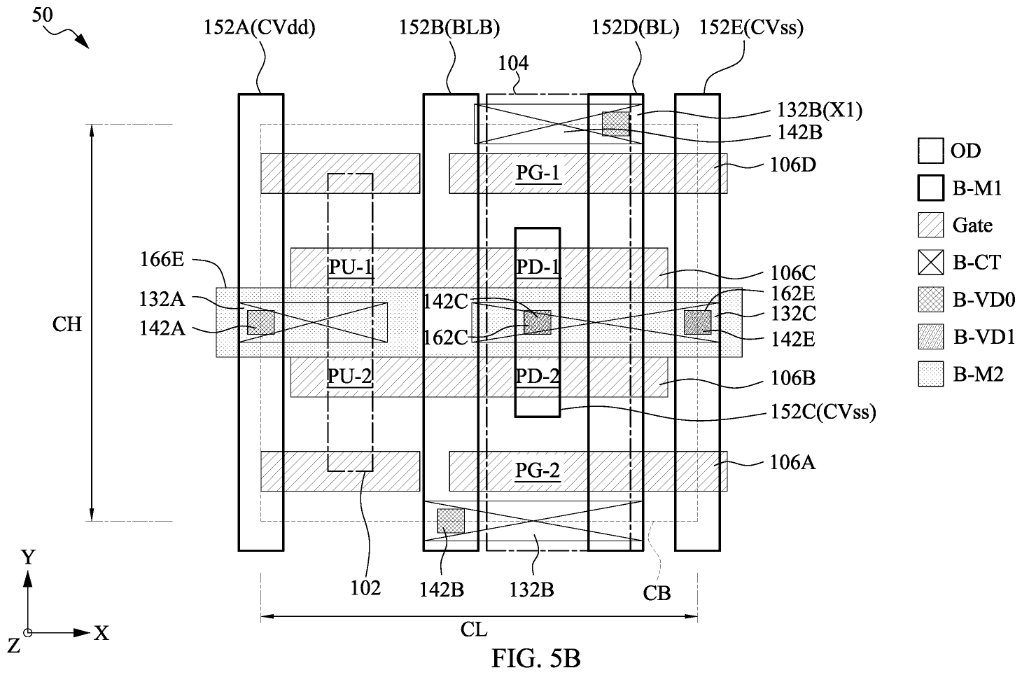

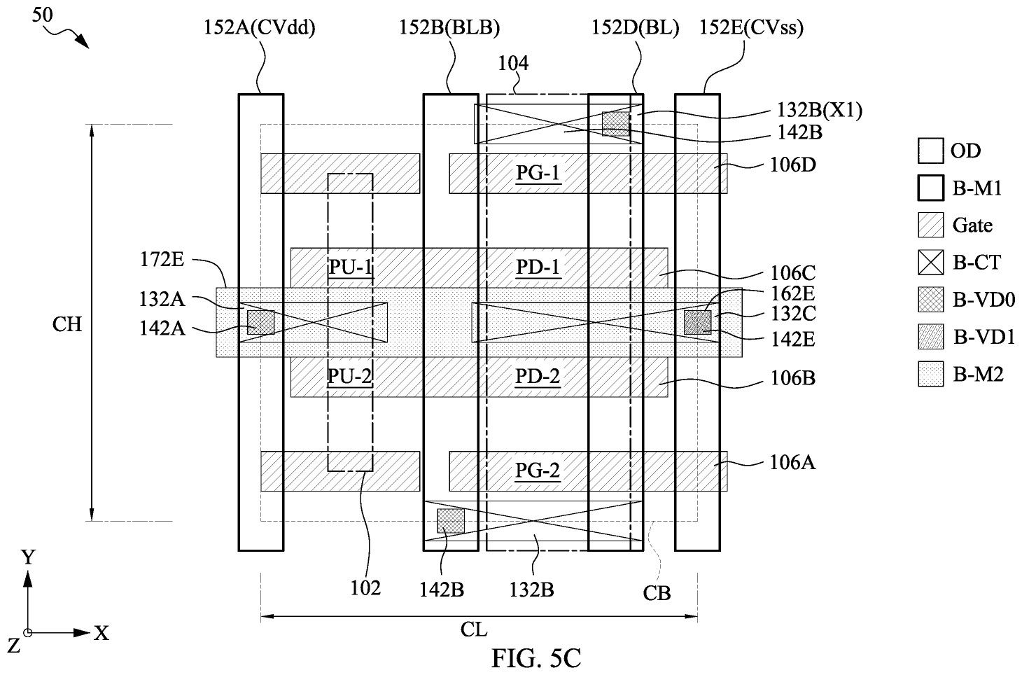

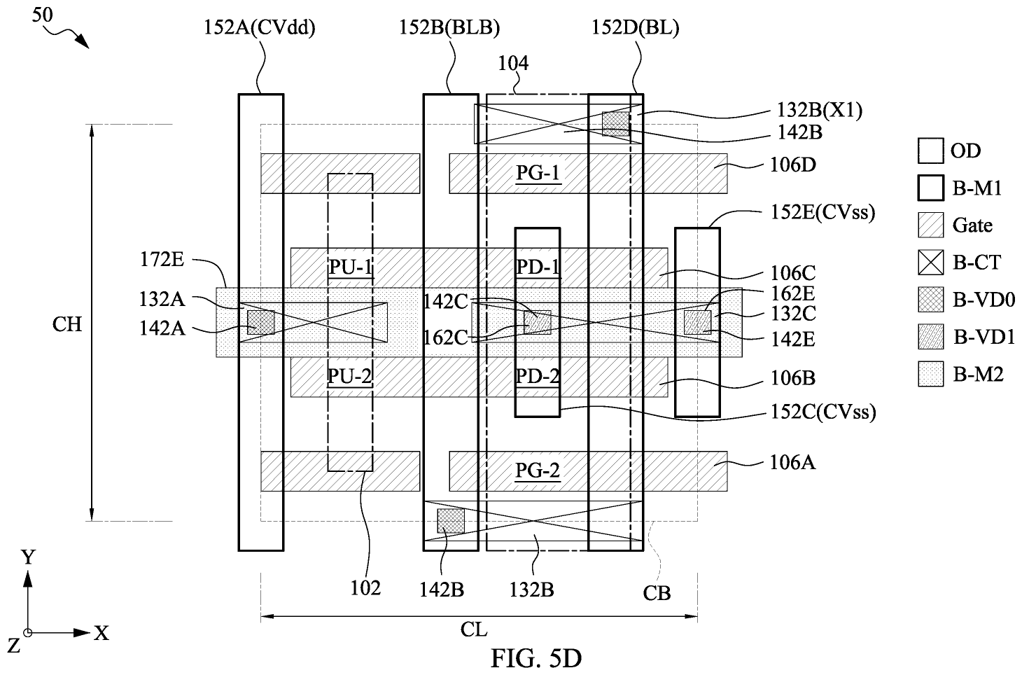

FIG. 5A is a top view of a cell 50 of a memory unit, in accordance with some embodiments of the present disclosure. The cell 50 is similar to the cell 20 in many aspects, and the similar aspects will not be repeated for brevity. The cell 50 is different from the cell 20 in that the front-side power rails CVdd and CVss implemented by the front-side conductive lines 122A and 122C are removed. The task of providing the first and second supply voltages will be handled by the backside conductive lines 152A, 152C and 152E.

FIGS. 5B to 5D are various bottom views of the cell 50 shown in FIG. 5A, in accordance with various embodiments of the present disclosure. Referring to FIG. 5B, the backside conductive lines 152C and 152E, configured to receive the second supply voltage CVss, are electrically connected to each other through the backside conductive via 162C and 162E, respectively, arranged in the backside conductive via layer BSV-1 and the backside conductive line 166E arranged in the backside conductive line layer BSM-2 below the backside conductive via layer BSV-1. It is noted that although the backside conductive line 166E extends over and crosses the backside conductive line 152A and 152B, they are not electrically connected.

Referring to FIG. 5C, the bottom view the cell 50 in FIG. 5C is different from that of the cell 50 shown in FIG. 5B in that the backside conductive vias 142C, 162C and the backside conductive line 152C are removed to increasing the line spacing for reducing the design complexity. Referring to FIG. 5D, the bottom view the cell 50 in FIG. 5D is different from that of the cell 50 shown in FIG. 5B in that the backside conductive line 152E is shortened along the direction of Y-axis. In some embodiments, the backside conductive lines 152C and 152E have substantially equal lengths measured along the Y-axis for reducing the coupled capacitance between the backside conductive lines 152C, 152E.

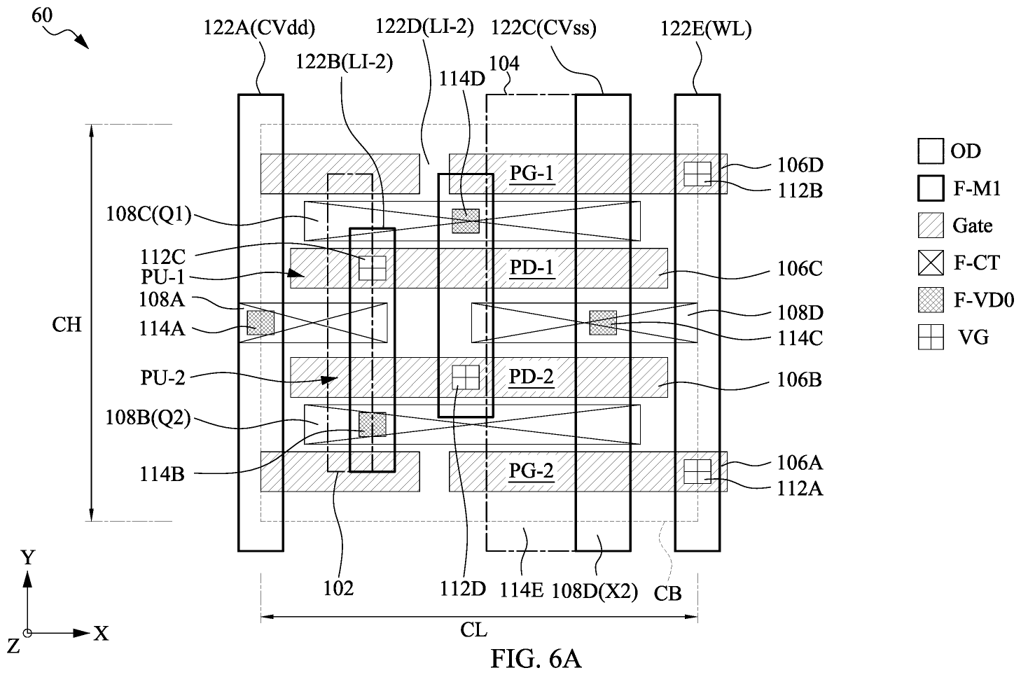

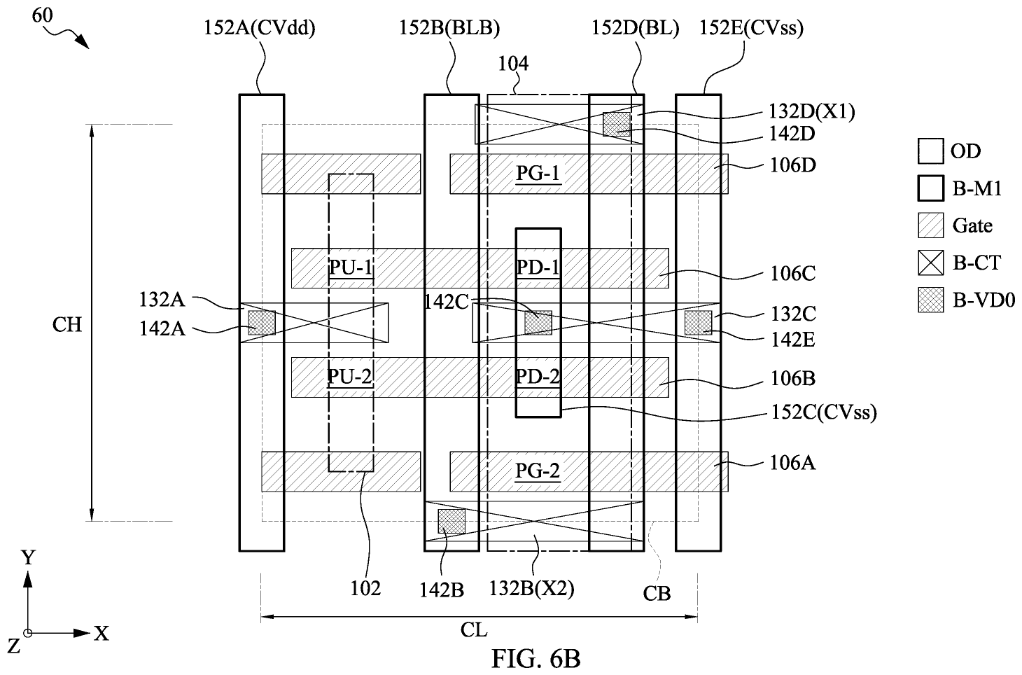

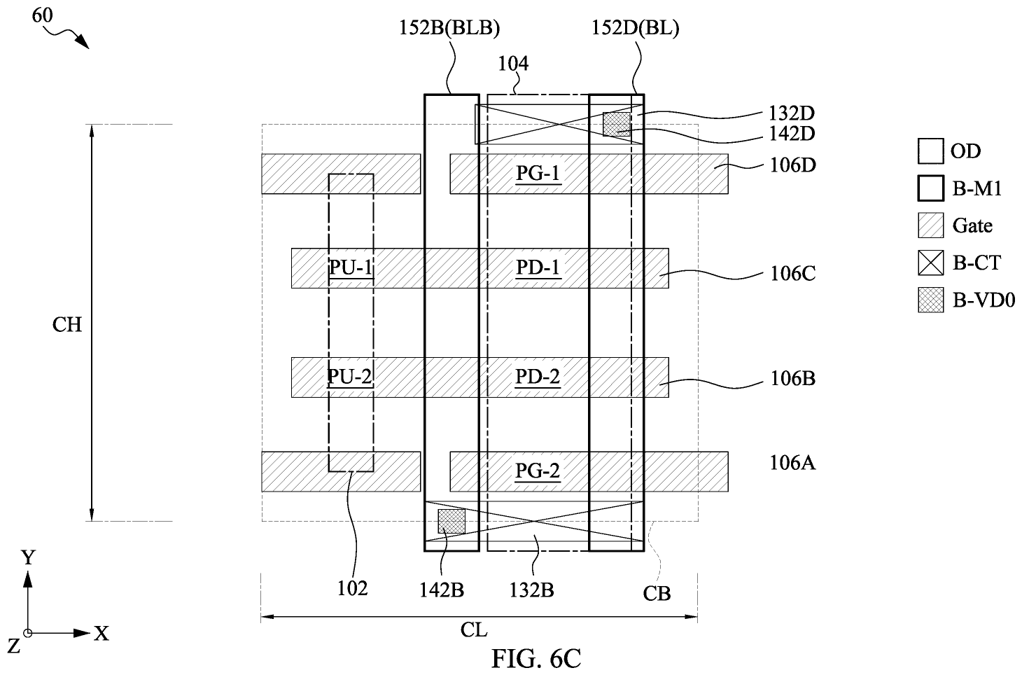

FIG. 6A is a top view of a cell 60 of a memory unit, in accordance with some embodiments of the present disclosure. The cell 60 shown in FIG. 6A is similar to that shown in FIG. 2A in many aspects, and the similar aspects will not be repeated for brevity. The cell 60 is different from the cell 20 in that the locations of the front-side power rail CVss implemented by the front-side conductive lines 122C and the local interconnection LI-1 implemented by the front-side conductive line 122D are interchanged.

FIGS. 6B and 6C are various bottom views of the cell 60 shown in FIG. 6A, in accordance with some embodiments of the present disclosure. The bottom view of the cell 60 shown in FIG. 6B is similar to that shown in FIG. 2B, and the similar aspects will not be repeated. The bottom view of the cell 60 shown in FIG. 6C is similar to that shown in FIG. 2B except that the backside power rail CVdd implemented by the backside conductive line 152A and the backside power rail CVss implemented by the backside conductive lines 152C, 152E are removed. The accompanying backside conductive vias 142A, 142C, 142E and the backside conductive lines 132A, 132C are also removed. The task of providing the first and second supply voltages CVdd, CVss are handled by the front-side conductive lines 122A and 122D.

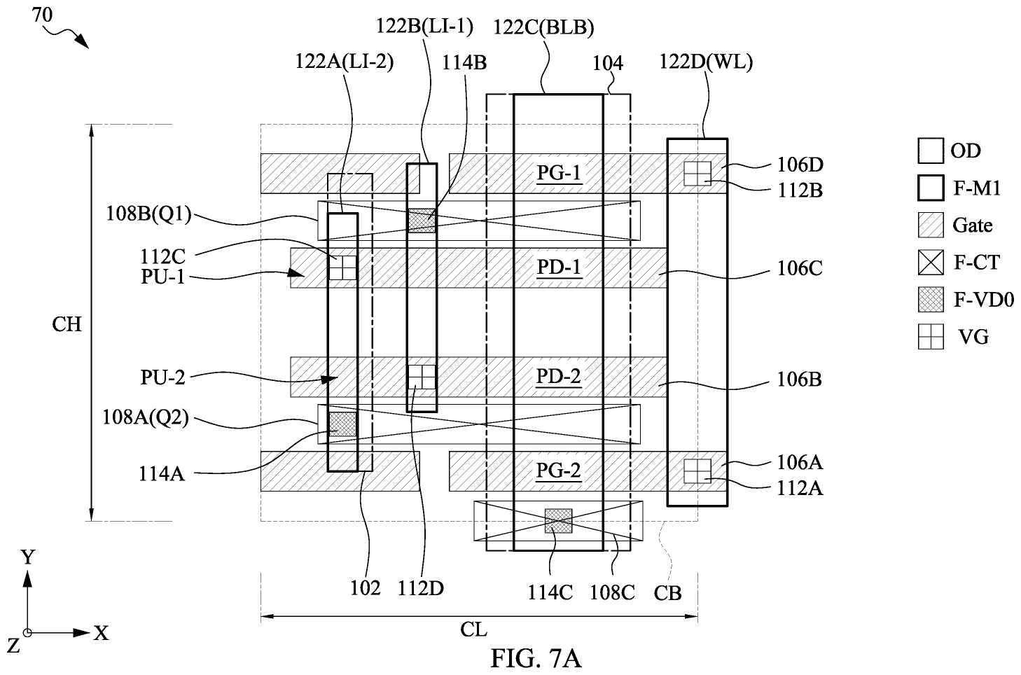

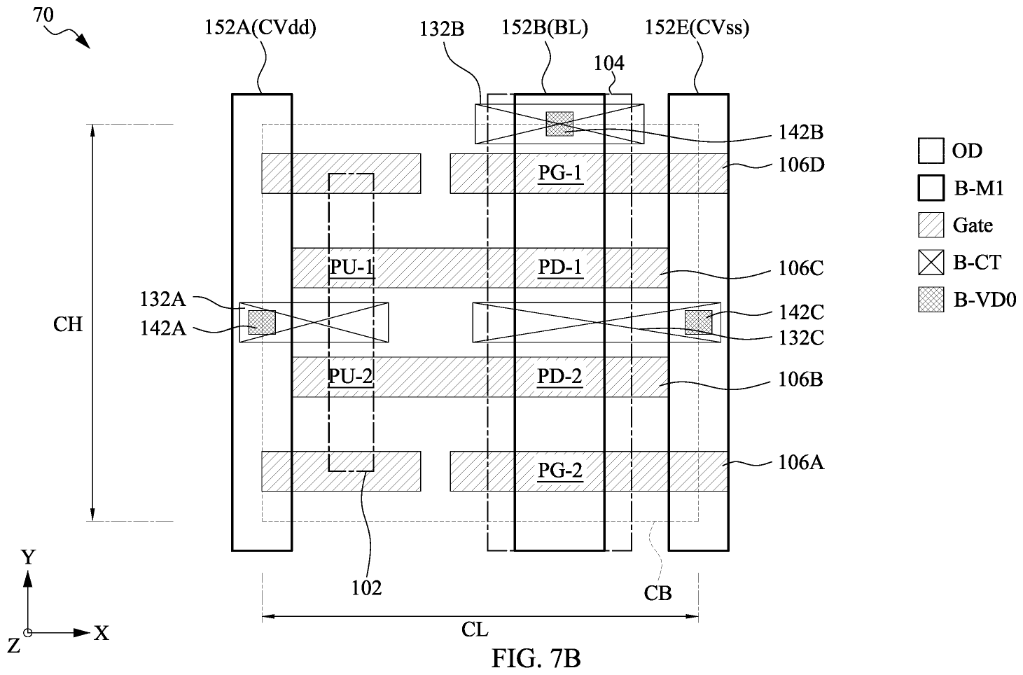

FIGS. 7A and 7B are a top view and a bottom view, respectively, of a cell 70 of a memory unit, in accordance with some embodiments of the present disclosure. The cell 70 shown in FIG. 7A is similar to that shown in FIG. 2A in many aspects, and the similar aspects will not be repeated for brevity. The cell 70 is different from the cell 20 in that the front-side power rail CVdd implemented by the front-side conductive line 122A is removed. Further, the front-side power rail CVss implemented by the front-side conductive line 122C is replaced by a front-side complementary bitline (BLB) implemented by the front-side conductive line 122C, where the backside complementary bitline (BLB) is removed as shown in FIG. 7B. Further, referring to FIG. 7B, the additional power rail CVss implemented by the backside conductive line 152C is also removed. As a result, the task of providing the first and second supply voltages CVdd, CVss are handled by the backside conductive lines 152A and 152E. Moreover, the pair of complementary bitlines BL, BLB are implemented by the backside conductive line 152B and the front-side conductive line 122C, respectively, i.e., the pair of complementary bitlines BL, BLB are arranged on opposite sides of the cell 70.

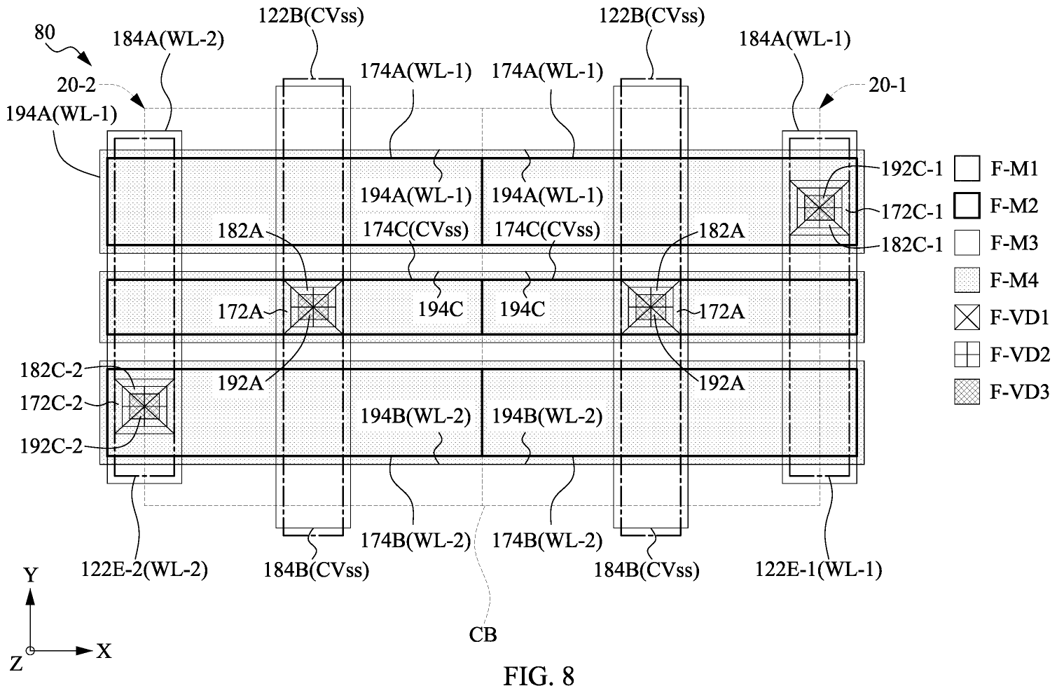

FIG. 8 is a top view of a design layout 80 of a pair of cells 20, in accordance with some embodiments of the present disclosure. The design layout 80 shown in FIG. 8 is similar to the design layout 30 shown in FIG. 3C in many aspects, and the similar aspects will not be repeated for brevity. The design layout 80 is different from the design layout 30 in that the design layout 80 further includes the layout of the front-side conductive via layer FSV-2 and the front-side conductive line layer FSM-3 over the front-side conductive via layer FSV-2. In some embodiments, the front-side power rails of the cells 20-1 and 20-2, configured to receive the second supply voltage CVss, extend to higher front-side layers and are implemented by the front-side conductive vias 182A and the front-side conductive lines 184A.

In some embodiments, the word line select signal WL-1 is further received by the front-side conductive lines 194A, extending across the cells 20-1 and 20-2, and the front-side conductive via 192C-1 to electrically connected to the underlying front-side conductive lines 184A. The parallel front-side conductive lines 194A and 174A may be electrically connected in a parallel connection to receive the word line select signal WL-1. As a result, the electrical resistance of the word line select signal WL-1 can be further reduced.

Similarly, in some embodiments, the word line select signal WL-2 is further received by the front-side conductive lines 194B, extending across the cells 20-1 and 20-2, and the front-side conductive via 192C-2 to electrically connected to the underlying front-side conductive lines 184A. The parallel front-side conductive lines 194B and 174B may be electrically connected in a parallel connection to receive the word line select signal WL-2. As a result, the electrical resistance of the word line select signal WL-2 can be further reduced.

FIG. 9A is block diagram a memory device 90, in accordance with some embodiments of the present disclosure. The memory device 90 includes a memory array 902 and peripheral circuits, e.g., a row decoder 904 and a column decoder 906. In some embodiments, the peripheral circuits further includes sensing amplifiers or write drivers integrated with the column decoder 906.

In some embodiments, the memory array 902 is formed of 32 memory units Mx (where x is a positive integer) arranged in four rows R1 through R4 and eight columns C1 through C8. In some embodiments, the memory array 902 is grouped into four memory groups Gᵢ, where i denotes N through N+3 with N being a natural number. Each memory group Gᵢ includes two columns of memory units Mx. In the depicted example, each memory group Gᵢ includes eight memory units M1 through M8 in two columns. The memory units Mx in the rows R1 through R4 are addressed by one of the two word lines extending over the corresponding memory units Mx. For example, referring to FIGS. 3C, 8 and 9A, the pair of cells 20-1 and 20-2 shown in FIG. 3C correspond to the pair of memory units M1 and M2 in columns C1 and C2 of FIG. 9A. The right-hand side cell 20-1 (the memory unit M1 in the dashed box of FIG. 9A) of FIG. 3C is controlled by the word line select signal WL-1 through the front-side conductive line 174A and the right-hand side conductive via 172C-1, while the left-hand side cell 20-2 of FIG. 3C (the memory unit M2 in the dashed box of FIG. 9A) is controlled by the word line select signal WL-2 through the front-side conductive line 174B and the left-hand side conductive via 172C-2. By application of the word line addressing scheme shown in FIG. 3C and the dashed box of FIG. 9A to the entire memory array 902, it can be observed that the each row R1 through R4 is addressed by one of the two word lines WL-k, WL-(k+1), where k-1, 3, 5, 7. In some embodiments, both the word lines WL-k, WL-(k+1), e.g., WL-1 and WL-2, of the respective row R1 through R4 extend across each memory unit Mx, e.g., memory units M1 and M2, in the same row. One half of the memory units Mx in each row is addressed by one of the word lines, e.g., WL-k, and the other half of the memory units Mx in the same row is addressed by the other one of the word lines, e.g., WL-(k+1).

Moreover, each memory unit Mx is addressed through a pair of complementary bitlines BL_i_1 or BL_i_2. For example, the four memory units M2, M4, M6 and M8 in the column C1 are addressed through the complementary bit line pairs BL_N_1, while the four memory units M1, M3, M5 and M7 in the column C2 are addressed through the complementary bit line pairs BL_N_2. Therefore, each pair of complementary bit lines BL_i_1 or BL_i_2 are configured to drive four memory units Mx in an access operation.

FIG. 9B is block diagram a memory device 91, in accordance with some comparative examples of the present disclosure. The memory device 91 includes a memory array 912 and peripheral circuits, e.g., a row decoder 914 and a column decoder 916. In some embodiments, the peripheral circuits further include sensing amplifiers or write drivers integrated with the column decoder 916.

In some embodiments, the memory array 912 is formed of 32 memory units Mx arranged in eight rows R1 through R8 and four columns C1 through C4. Therefore, the total number of memory units Mx of the memory array 902 is equal to that of the memory array 912. The memory units Mx in the row R1 through R8 of the memory array 912 are addressed by a corresponding word line WL-1 through WL-8, where each word line WL-1 through WL-8 crosses only one corresponding row R1 through R8, as shown in FIG. 9B. Moreover, each memory unit Mx is addressed through a pair of complementary bitlines BL_i. Therefore, each pair of complementary bit lines BL_i are configured to drive eight memory units Mx in an access operation.

Through the comparison of the memory device 90 and the memory device 91, it can be found that in the memory device 90 of the proposed addressing scheme, given the same number of memory units Mx, each pair of the complementary bitlines BL_i_1 or BL-i_2 needs to address or drive only four memory units Mx, which is only one half of the number of memory units Mx driven by the pair of complementary bit lines BL_i in the comparative example memory device 91. As a result, the driving current for each memory unit Mx in the memory device 90 can be doubled as compared to the memory device 90. The access speed of the memory device 90 can be increased accordingly. In some embodiments, one more addressing bit is required for the memory device 90 as compared to the memory device 91 to select the proper word line WL-k or WL-(k+1) during an access operation.

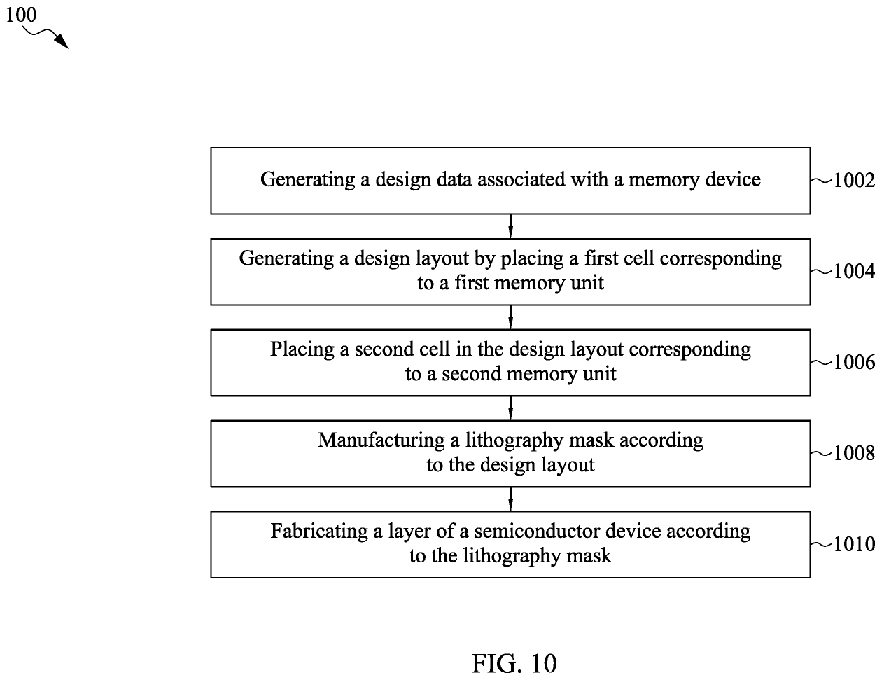

FIG. 10 is a flowchart of a method 100 of manufacturing a semiconductor device, in accordance with some embodiments of the present disclosure. It should be understood that additional steps can be provided before, during, and after the steps shown in FIG. 10, and some of the steps described below can be replaced or eliminated in other embodiments of the method 100. The order of the steps may be interchangeable.

At step 1002, a design data is generated or received which is associated with a memory device. The design data may be represented as a netlist, a schematic diagram, a circuit diagram or the like. In some embodiments, the memory device includes one or more logic gate devices in various types, such as a NAND gate, an inverter gate, an XOR gate, an AND gate, a NOR gate, an AOI gate, or other suitable logic gate devices. In some embodiments, the design data in step 1002 is generated during a synthesis stage of a design flow for manufacturing a memory device.

At step 1004, a design layout is generated by placing a first cell in the design layout, the first cell corresponding to a first memory unit, e.g., the cells 20, 40, 50, 60, 70, and 80. The step 1004 may be performed during a placement and routing stage of a design flow for manufacturing a memory device.

At step 1006, a second cell corresponding to a second memory unit is placed in the design layout, where the second cell may be, e.g., the cells 20, 40, 50, 60, 70, and 80. The second cell may be abutted to the first cell in a manner similar to the design layout 30 or 80. The step 1006 may be performed during a placement and routing stage of a design flow for manufacturing a memory device.

At step 1008, a lithography mask is manufactured according to the design layout. At step 1010, a semiconductor device fabricated in which a layer of the memory device is formed according to the lithography mask. In some embodiments, the memory device is fabricated according to the design layout.

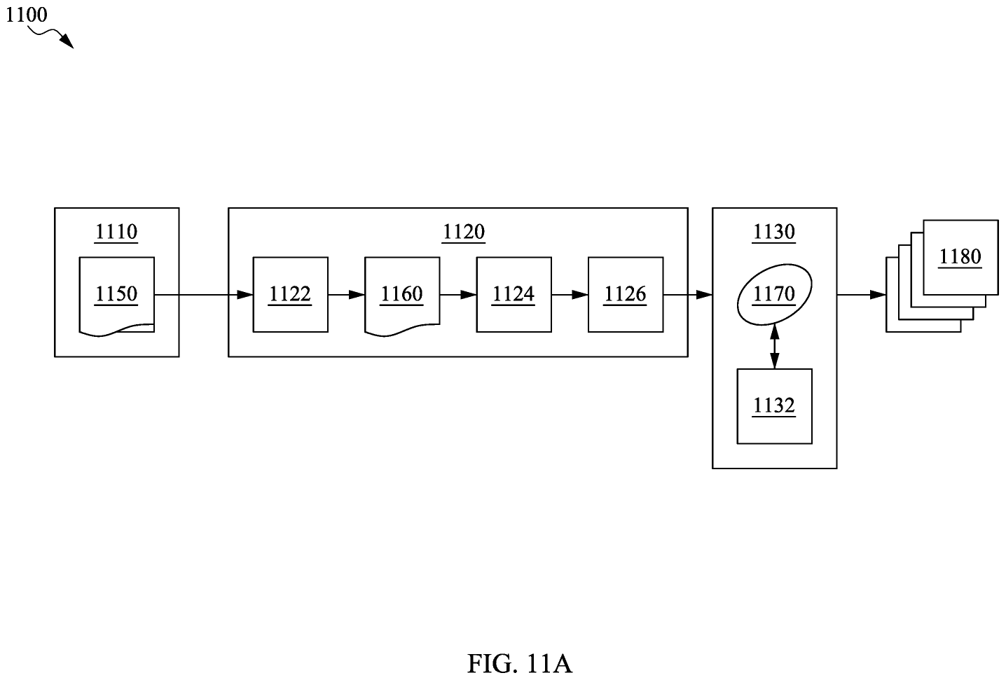

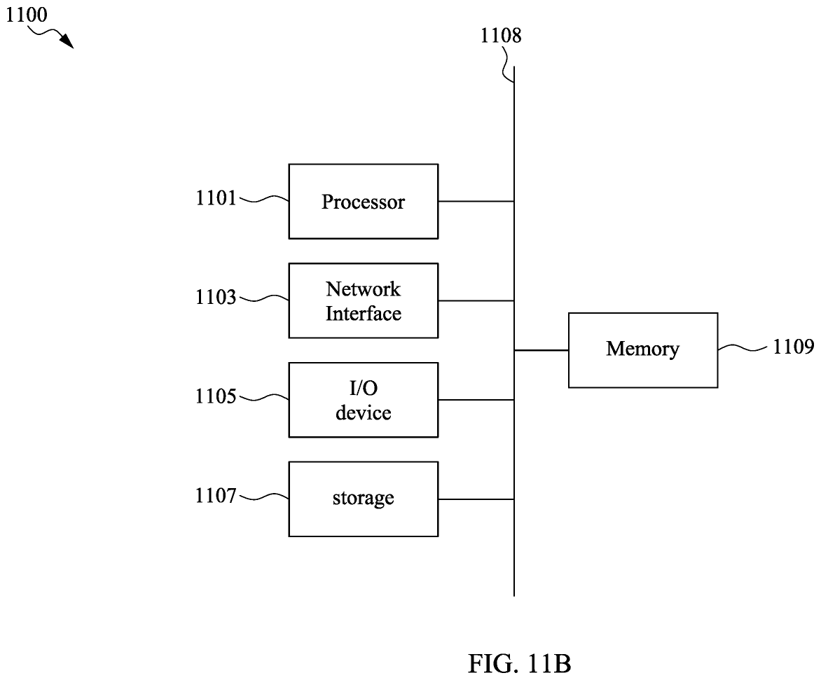

FIG. 11A is a schematic diagram 1100 showing an integrated circuit (IC) manufacturing system, in accordance with some embodiments. The IC manufacturing system 1100 is configured to manufacture an IC device 1180 through a plurality of entities, such as a design subsystem 1110, a mask subsystem 1120, and a fabrication subsystem 1130. The entities in the IC manufacturing system 1100 may be linked by a communication channel, e.g., a wired or wireless channel, and interact with one another through a network, e.g., an intranet or the internet. In an embodiment, the design subsystem 1110, the mask subsystem 1120 and the fabrication subsystem 1130 belong to a single entity, or are operated by independent parties.

The design subsystem 1110, which may be provided by a design house or a layout design provider, generates a design layout 1150, e.g., the cells 20, 40, 50, 60, 70, and design layouts 30, 80, in a design phase for the IC devices 1180 to be fabricated. The design subsystem 1110 may perform the layout methods discussed in the present disclosure to generate the design layout 1150, e.g., the design layouts shown with reference to the figures of the present disclosure. In an embodiment, the design subsystem 1110 operates a circuit design procedure to generate the design layout 1150. The design subsystem 1110 may include further one or more steps, such as logic design, physical design, pre-layout simulation, placement and routing, timing analysis, parameter extraction, design rule check and post-layout simulation, to generate the design layout 1150. The design layout 1150 may be converted from description texts into their visual equivalents to show a physical layout of the depicted patterns, such as the dimensions, shapes and locations thereof. In an embodiment, the design layout 1150 can be expressed in a suitable file format such as GDSII, DFII, OASIS, or the like.

The mask subsystem 1120 receives the design layout 1150 from the design subsystem 1110 and manufactures one or more masks (photomask, lithography masks or reticles) according to the design layout 1150. In an embodiment, the mask subsystem 1120 includes a mask data preparation block 1122, a mask fabrication block 1124 and a mask inspection block 1126. The mask data preparation block 1122 modifies the design layout 1150 so that a revised design layout 1160 can allow a mask writer to transfer the design layout 1150 to a writer-readable format.

The mask fabrication block 1124 is configured to fabricate the one or more masks by preparing a substrate based on the design layout 1160 provided by the mask data preparation block 1122. A mask substrate is exposed to a radiation beam based on the pattern of the design layout 1160 in a writing operation, which may be followed by an etching operation to leave the patterns corresponding to the design layout 1160. In an embodiment, the mask fabrication block 1124 includes a checking procedure to ensure that the design layout 1160 complies with requirements of a mask writer and/or a mask manufacturer to generate the mask as desired. An electron-beam (e-beam), multiple e-beams, an ion beam, a laser beam or other suitable writer source may be used to transfer the patterns.

After the one or more masks are fabricated, the mask inspection block 1126 inspects the fabricated masks to determine if any defects, such as full-height and non-full-height defects, exist in the fabricated mask. If any defects are detected, the mask may be cleaned or the design layout in the mask may be modified.

The fabrication subsystem 1130 is an IC manufacturing entity that includes multiple manufacturing facilities or tools for the fabrication of a variety of the IC devices 1180. The fabrication subsystem 1130 uses the mask fabricated by the mask subsystem 1120 to generate a wafer 1170 having a plurality of IC devices 1180 thereon. The wafer 1170 includes a semiconductor substrate and optionally various layers formed thereon. The operations provided by the manufacturing facilities or tools may include, but are not limited to, photolithography, deposition, sputtering, etching, cleaning, polishing, diffusion, ion implantation and annealing. In some embodiments, test structures may be formed on the wafer 1170 to generate test data indicative of the quality of the fabricated wafer 1170. In an embodiment, the fabrication subsystem 1130 includes a wafer testing block 1132 configured to ensure that the wafer 1170 conforms to physical manufacturing specifications and mechanical and/or electrical performance specifications. After the wafer 1170 passes the testing procedure performed by the wafer testing block 1132, the wafer 1170 may be diced (or sliced) along the scribe line regions to form separate IC devices 1180. The dicing process can be accomplished by scribing and breaking, by mechanical sawing (e.g., with a dicing saw) or by laser cutting.

FIG. 11B is a schematic diagram of a system 1100 for implementing or storing the design layouts discussed above, in accordance with some embodiments. The system 1100 includes a processor 1101, a network interface 1103, an input and output (I/O) device 1105, a storage device 1107, a memory 1109, and a bus 1108. The bus 1108 couples the network interface 1103, the I/O device 1105, the storage device 1107, the memory 1109 and the processor 1101 to each other.

The processor 1101 is configured to execute program instructions that include a tool configured to generate the design layouts as described and illustrated with reference to figures of the present disclosure.

The network interface 1103 is configured to access program instructions and data accessed by the program instructions stored remotely through a network (not shown).

The I/O device 1105 includes an input device and an output device configured to enable user interaction with the system 1100. In some embodiments, the input device includes, for example, a keyboard, a mouse, and other devices. Moreover, the output device includes, for example, a display, a printer, and other devices.

The storage device 1107 is configured for storing the design layouts, one or more cell libraries including the configurations and settings of the standard cells as discussed previously, program instructions and data accessed by the program instructions. In some embodiments, the storage device 1107 includes a non-transitory computer-readable storage medium, for example, a magnetic disk and an optical disk.

The memory 1109 is configured to store program instructions to be executed by the processor 1101 and data accessed by the program instructions. In some embodiments, the memory 1109 includes any combination of a random access memory (RAM), some other volatile storage device, a read-only memory (ROM), and some other non-volatile storage device.

In accordance with some embodiments of the present disclosure, a method is provided. The method includes receiving design data of a memory device; and generating a design layout including a first cell according to the design data. The first cell includes a first, a second, a third, and a fourth gate structures parallel to each other and extending in a first direction. The first cell further includes: a data storage element arranged in a device layer and comprising a first data node and a second data node, wherein the data storage element further comprises four transistors associated with the second and the third gate structures; a first access transistor and a second access transistor arranged in the device layer and coupled to the first data node and the second data node, respectively; a first conductive line extending in a second direction and coupled to gate structures of the first access transistor and the second access transistor, respectively; and a second conductive line and a third conductive line extending in the second direction and each coupled to a source/drain region of the respective first and second access transistors.

In accordance with some embodiments of the present disclosure, a method is provided. The method includes receiving design data of a memory device; and generating a design layout including a first cell according to the design data. The first cell includes: a data storage element arranged in a device layer and comprising a first data node and a second data node; a first access transistor and a second access transistor arranged in the device layer and coupled to the first data node and the second data node, respectively; a first conductive line extending in a column direction in a first layer over the device layer and electrically connected to gate structures of the first access transistor and the second access transistor; and a second conductive line and a third conductive line extending in the column direction and electrically connected to a source/drain region of the respective first and second access transistors. At least at least one of the second and third conductive lines is arranged in a second layer on one side of the device layer opposite to the first layer.

In accordance with some embodiments of the present disclosure, a memory array includes: a first memory unit including a data storage element arranged in a device layer and comprising a first data node and a second data node; a first access transistor and a second access transistor arranged in the device layer and coupled to the first data node and the second data node, respectively; a first conductive line extending in a first direction in a first layer over the device layer and electrically connected to gate structures of the first access transistor and the second access transistor, respectively; and a second conductive line and a third conductive line extending in the first direction and electrically connected to a source/drain region of the respective first and second access transistors. At least at least one of the second and third conductive lines is arranged in a second layer on one side of the device layer opposite to the first layer.

The foregoing outlines structures of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
receiving design data of a memory device; and
generating a design layout comprising a first cell according to the design data, the first cell comprising a first, a second, a third, and a fourth gate structures parallel to each other and extending in a first direction, wherein the first cell further comprises:
a data storage element arranged in a device layer and comprising a first data node and a second data node, wherein the data storage element further comprises four transistors associated with the second and the third gate structures;
a first access transistor and a second access transistor arranged in the device layer and coupled to the first data node and the second data node, respectively;
a first conductive line extending in a second direction and coupled to gate structures of the first access transistor and the second access transistor, respectively; and
a second conductive line and a third conductive line extending in the second direction and each coupled to a source/drain region of the respective first and second access transistors.

2. The method of claim 1, further comprising manufacturing the memory device according to the design layout.

3. The method of claim 1, wherein the first conductive line is arranged in a first layer over the device layer, and wherein at least one of the second and the third conductive lines is arranged in a second layer below the device layer.

4. The method of claim 3, wherein the second and third conductive line are arranged in the second layer.

5. The method of claim 4, wherein the first cell further comprises a fourth conductive line extending in the second direction and configured to receive a first supply voltage, and a fifth conductive line extending in the second direction and configured to receive a second supply voltage, wherein at least one of the fourth and the fifth conductive lines is arranged in the second layer.

6. The method of claim 5, wherein the second, the third, the fourth and the fifth conductive lines are arranged in the second layer.

7. The method of claim 5, wherein the first cell further comprises a sixth conductive line extending in the second direction in the second layer and configured to receive the second supply voltage, wherein the fifth conductive line and the sixth conductive line are separated by one of the second conductive line and the third conductive line.

8. The method of claim 7, wherein the fifth conductive line and the sixth conductive line have different lengths measured in the second direction.

9. The method of claim 1, wherein the data storage element further comprises a first source/drain region and a second source/drain region arrange in the device layer on outer sides of the second gate structure and the third gate structure, wherein the first cell further comprises a seventh conductive line electrically connecting the second gate structure and the second source/drain region, and an eighth conductive line electrically connecting the third gate structure and the first source/drain region.

10. The method of claim 1, wherein the first conductive line is aligned with a cell side of the first cell.

11. A method, comprising:
receiving design data of a memory device; and
generating a design layout comprising a first cell according to the design data, wherein the first cell comprises:
a data storage element arranged in a device layer and comprising a first data node and a second data node;
a first access transistor and a second access transistor arranged in the device layer and coupled to the first data node and the second data node, respectively;
a first conductive line extending in a column direction in a first layer over the device layer and electrically connected to gate structures of the first access transistor and the second access transistor; and
a second conductive line and a third conductive line extending in the column direction and electrically connected to a source/drain region of the respective first and second access transistors,
wherein at least at least one of the second and third conductive lines is arranged in a second layer on one side of the device layer opposite to the first layer.

12. The method of claim 11, wherein the design layout define a gate pitch as a pitch between adjacent gate structures extending in a row direction, wherein the first cell has a cell height of four times the gate pitch measured in the column direction.

13. The method of claim 11, wherein the first cell further comprises a fourth conductive line extending in a third layer over the first layer in a row direction and electrically coupled to the first conductive line.

14. The method of claim 13, further comprising placing a second cell in the design layout, the second cell abutted to the first cell, wherein the second cell comprises:
a fifth conductive line extending in the second layer in the column direction and configured to control access transistors of the second cell; and
a sixth conductive line extending in the third layer in the row direction, wherein both the fourth conductive line and the sixth conductive line extends across the first and the second cells.

15. The method of claim 14, wherein the first cell and the second cell are symmetrically arranged about a boundary line between the first cell and the second cell.

16. The method of claim 11, wherein the second conductive line and the third conductive line are arranged on opposite sides of the device layer.

17. A memory array, comprising:
a first memory unit comprising:
a data storage element arranged in a device layer and comprising a first data node and a second data node;
a first access transistor and a second access transistor arranged in the device layer and coupled to the first data node and the second data node, respectively;
a first conductive line extending in a first direction in a first layer over the device layer and electrically connected to gate structures of the first access transistor and the second access transistor, respectively; and
a second conductive line and a third conductive line extending in the first direction and electrically connected to a source/drain region of the respective first and second access transistors,
wherein at least at least one of the second and third conductive lines is arranged in a second layer on one side of the device layer opposite to the first layer.

18. The memory array of claim 17, wherein the first memory unit further comprises:
a fourth conductive line arranged extending in the first direction and configured to receive a first supply voltage; and
a fifth conductive line arranged in the first direction and configured to receive a second supply voltage.

19. The memory array of claim 18, wherein the memory array further comprises a second memory unit abutted to the first memory unit in the first direction, wherein the fourth conductive line is shared by the first and the second memory units.

20. The memory array of claim 18, wherein the fourth conductive line and the fifth conductive line are arranged in the second layer.
